(19) United States
(12) Patent Application Publication
(10) Pub. No.: US 2024/0365440 A1
(43) Pub. Date: Oct. 31, 2024

(54) ELECTRO-THERMAL MULTILAYER, SYSTEM AND METHOD FOR DEFROSTING, DESNOWING AND DEICING

(71) Applicant: The Board of Trustees of the University of Illinois, Urbana, IL (US)

(72) Inventors: Siavash Khodakarami, Urbana, IL (US); Nenad Miljkovic, Urbana, IL (US); Longnan Li, Changchun (CN); Muhammad Jahidul Hoque, Urbana, IL (US); Alexandra Efterpy Solecki, Urbana, IL (US); Pouya Kabirzadeh, Urbana, IL (US); Wentao Yang, Urbana, IL (US); Andrew Stillwell, Champaign, IL (US); Nicole Stokowski, Champaign, IL (US)

(21) Appl. No.: 18/647,951

(22) Filed: Apr. 26, 2024

Related U.S. Application Data
(60) Provisional application No. 63/462,771, filed on Apr. 28, 2023.

(51) Int. Cl. H05B 3/26; B64D 15/12

(52) U.S. Cl. CPC H05B 3/26; B64D 15/12

(57) ABSTRACT

A system configured for electro-thermal defrosting, desnowing and/or deicing includes (a) a component susceptible to accumulation of ice, frost, and/or snow, and (b) an electro-thermal multilayer on the component. The electro-thermal multilayer comprises a heating layer on an insulating layer, where the heating layer is configured for electrical connection to a source of pulsed power. The electro-thermal multilayer optionally includes a superhydrophobic layer. The component may be a photovoltaic panel, a wind turbine blade, a heat exchanger coil or fin, or an aircraft wing, e.g., of an electrified aircraft. The electro-thermal multilayer may be adhered to the component as a coating or removably secured to the component as a module.

### RELATED APPLICATION

The present patent document claims the benefit of priority under 35 U.S.C. 119 (e) to U.S. Provisional Patent Application No. 63/462,771, which was filed on Apr. 28, 2023, and is hereby incorporated by reference in its entirety.

### FEDERALLY SPONSORED RESEARCH AND DEVELOPMENT

This invention was made with government support under DE-AR0001594 awarded by the US Department of Energy. The United States Government has certain rights in the invention.

### TECHNICAL FIELD

The present disclosure is related generally to heating technology and more particularly to pulsed resistive or Joule heating for snow, ice, and frost removal.

### BACKGROUND

The rapid anthropomorphic emission of greenhouse gases is contributing to global climate change, resulting in the increased frequency of extreme weather events, including unexpected snow, frost, and ice accretion in warmer regions that typically do not encounter these conditions. Adverse weather events create challenges for energy systems such as wind turbines and photovoltaics. To maintain energy efficiency and operational fidelity, snow, frost, and ice need to be removed from these energy systems efficiently and rapidly. Existing removal methods are energy-intensive, expensive to implement and/or slow.

Another challenge is aircraft icing, which can have enormous economic and personal costs to society. Icing can initiate when the aircraft is on the ground with sub-zero ambient temperatures and adverse weather conditions. Icing can also occur in-flight due to sub-zero temperatures and high moisture content at certain elevations. Furthermore, impact and accretion of supercooled water droplets represents a secondary in-flight icing mechanism. Even aircraft with functioning ice mitigation systems can crash, as was the case for American Eagle Flight 4184, which resulted in 64 fatalities. Less extreme outcomes such as grounded or delayed flights due to ice and snow accumulation are more common occurrences in colder climates. From an economic standpoint, current ice and snow prevention techniques, such as ground-based chemical deicing, cost international airports upwards of hundreds of millions of US dollars per year due to the need for chemical separation of the runoff fluid after deicing is complete. It also has been recognized that chemical deicing fluids such as propylene glycol and ethylene glycol may have harmful environmental impacts.

Better deicing, desnowing and defrosting strategies would be advantageous for aerospace and renewable energy systems, among other applications.

### BRIEF SUMMARY

An electro-thermal multilayer, system and method for defrosting, desnowing, and deicing are described in this disclosure.

The electro-thermal multilayer comprises: a heating layer on an insulating layer; and a superhydrophobic layer on the insulating layer. In some examples, the heating layer and the superhydrophobic layer may be on opposing sides of the insulating layer; that is, the insulating layer may be between the heating layer and the superhydrophobic layer. In other examples, the heating layer and the superhydrophobic layer may be on the same side of the insulating layer; more specifically, the superhydrophobic layer may be directly on the heating layer and the heating layer may be directly on the insulating layer.

The system comprises (a) a component susceptible to accumulation of ice, frost, and/or snow, and (b) an electro-thermal multilayer disposed on the component. The electro-thermal multilayer comprises a heating layer on an insulating layer, and optionally includes a superhydrophobic layer on the insulating layer. The heating layer is configured for electrical connection to a source of pulsed power.

The method includes providing a component having an electro-thermal multilayer thereon, where the electro-thermal multilayer comprises a heating layer on an insulating layer and optionally includes a superhydrophobic layer on the insulating layer. The component is used in environmental conditions sufficient to freeze water, whereby frost, snow, and/or ice accumulates on part or all of the component. The frost, snow, and/or ice is subjected to gravitational and/or shear forces during use of the component. An electrical pulse is applied to the heating layer to induce interfacial melting of the frost, snow, and/or ice, and a melted layer forms on the component. The frost, snow, and/or ice slides along the melted layer in a direction determined by the gravitational and/or shear forces and is thereby removed from the component.

### BRIEF DESCRIPTION OF THE DRAWINGS

FIGS. 1A and 1B are cross-sectional schematics of examples of an electro-thermal multilayer including a heating layer, an insulating layer and a superhydrophobic layer.

FIG. 2 is a cross-sectional schematic of an example of an electro-thermal multilayer including a heating layer and an insulating layer.

FIGS. 3A-3C are top-view schematics showing examples of patterned heating layers.

FIG. 4 shows, on the left-hand side, a system including an electro-thermal multilayer (heating layer on insulating layer) disposed on a substrate of a component, where ice has accumulated on the component, and, on the right-hand side, a conceptual schematic of the heat intensity and temperature distribution for pulsed heating (top) compared to steady heating (bottom).

FIG. 5A plots the estimated pulse time for removal of ice from a wing of a Boeing 747 using the pulsed Joule heating approach compared to steady heating for complete melting of the ice layer.

FIG. 5B plots the estimated energy to fully deice the wing of a Boeing 747 as a function of ice thickness for both steady and pulsed Joule heating.

FIG. 6A is an exploded view of a system including an electro-thermal multilayer applied as a module on a component (a photovoltaic panel in this example).

FIG. 6B shows the system of FIG. 6A after pulsed power has been applied to the electro-thermal multilayer and the photovoltaic panel power is recovered

FIG. 7A shows a component that includes an electro-thermal multilayer; in this example, the component is an aircraft wing, and the electro-thermal multilayer is on the leading edge of the wing.

FIGS. 7B and 7C show two embodiments of the electro-thermal multilayer of FIG. 7A.

FIG. 8A shows a schematic used for heating layer calculations to assess voltage requirements for different conductive materials and layer thicknesses.

FIG. 8B shows an example configuration of a voltage application to a leading edge of a wing.

FIG. 8C plots heating layer thickness versus required voltage for titanium, indium-tin oxide (ITO), and a nickel-chromium alloy, as calculated for an exemplary quarter wing leading edge.

FIGS. 9A-9F show exemplary steps in a patterning process to produce a patterned heating layer.

FIG. 10 is a cross-sectional schematic showing an electro-thermal multilayer including a superhydrophobic layer, where the inset schematic provides a detailed view.

FIG. 11A shows an aircraft pulsed deicing circuit schematic for in-flight deicing using electric power from an aircraft generator and on-board electrical storage (battery). The black dotted bounding box in FIGS. 11A-11C represents the aircraft and components that may be included on the aircraft for each strategy.

FIG. 11B shows an aircraft pulsed deicing circuit schematic for in-flight deicing using supercapacitors that are charged every time the flight is on ground.

FIG. 11C shows an aircraft pulsed deicing circuit schematic for in-flight deicing and on-ground deicing, with the majority of charging and pulse electrical infrastructure on the ground to be used prior to flight or during takeoff on the runway.

FIG. 12A is a schematic of a NACA 12 airfoil profile used in a finite difference method model with air speed demarked as U_{∞} and the definition of x and y distances; also illustrated is the chord length (Iₛ) used to define the aircraft wing length.

FIG. 12B shows a close-up view (dotted green box in FIG. 12A) of the airfoil depicting each functional layer along with the boundary layer velocity profile (u(y)) along the wing at the ice surface.

FIG. 12C shows a close-up view of the dotted blue region demarked in FIG. 12B near the heating layer showing the melted ice layer with Couette flow having a melt water velocity profile of u_{w}(y).

FIGS. 13A and 13B plot pulse power required (P, left axis) and heat flux (q″, right axis) for deicing as a function of pulse duration (Δtₚᵤₗₛₑ) for (FIG. 13A) various insulating layer thicknesses (tᵢ) with a fixed insulator thermal conductivity of kᵢ=1 W/(m·K), and (FIG. 13B) various insulator thermal conductivities (kᵢ) with a fixed insulator thickness of tᵢ=1 mm; the analysis used a Boeing 747 aircraft wing as a deicing platform, which has an icing area of A=16 m², and the simulation assumed a starting ice thickness of t_{ice}=5 mm and an air flow velocity of U=250 m/s.

FIGS. 14A and 14B plot power required (P, left axis) and heat flux (q″, right axis) by a Boeing-747 scale aircraft (A=16 m²) as a function of pulse time (Δtₚᵤₗₛₑ) for (FIG. 14A) a subset of conductive materials having a heating layer thickness of tₕ=1 mm, and (FIG. 14B) for a variety of heater layer thicknesses assuming cupro-nickel (Cu—Ni(70-30)) as the conductive material; the simulation assumed a starting ice thickness of t_{ice}=5 mm and an air-speed of U=250 m/s.

FIGS. 15A and 15B plot power (P) and energy (E), respectively, required to achieve complete deicing as a function of pulse time (Δtₚᵤₗₛₑ) for a variety of air speeds (Uᵣₑₗ=U_{∞}), ambient temperature of −15° C., and aircraft length scales, where the aircraft considered are Cessna (A=1 m²), Embraer (A=4 m²) and Boeing-747 (A=16 m²) and the legend shown in FIG. 15A applies also to FIG. 15B.

FIGS. 16A-16C plot maximum insulating layer temperature (T_{i,max}) during the pulsed deicing cycle as a function of insulating layer thickness (tᵢ) for a variety of insulator thermal conductivities (kᵢ) on a Cessna-172, Embraer-175, and Boeing-747 aircraft wing, respectively, where the legend applies to all three plots and initial temperatures were assumed to be −15° C. for all results.

FIGS. 17A-17C illustrate an exemplary process to produce a superhydrophobic layer including nanostructured surface protrusions (comprising boehmite) conformally coated with a hydrophobic species.

FIG. 18 includes simulation results showing melt fraction as a function of pulse time and input energy for an electro-thermal multilayer including an indium-tin oxide heating layer on a glass substrate.

FIG. 19A plots energy density required for defrosting utilizing an electro-thermal multilayer with (circles) and without (squares) a superhydrophobic layer as a function of frost thicknesses (frosting time).

FIG. 19B shows a defrosting regime map, where data points not on boundaries are omitted for clarity.

FIG. 19C plots energy density required for defrosting for three consecutive frosting/defrosting cycles without cleaning the surface after each cycle where the red bars represent data obtained utilizing an electro-thermal multilayer without the superhydrophobic layer, and the green bars represent data obtained utilizing an electro-thermal multilayer including the superhydrophobic layer.

FIGS. 19D and 19E plot power density and energy density versus pulse width for an electro-thermal multilayer including the superhydrophobic layer.

FIG. 20 shows a plot of apparent advancing and receding contact angles versus number of cycles (up to 1000) obtained from thermal cycling (cyclic frosting-defrosting) testing of a superhydrophobic layer.

FIG. 21 shows a plot of advancing contact angle versus time (up to 750 hours) obtained from weathering testing of a superhydrophobic layer.

FIGS. 22A-22D provide grayscale infrared images showing local temperatures in different regions of patterned heating layers while heated at 60 V.

### DETAILED DESCRIPTION

Described in this disclosure are various embodiments of an electro-thermal multilayer designed for defrosting, desnowing and deicing, along with a system that includes the electro-thermal multilayer. Also described is a pulsed Joule heating method to effect defrosting, desnowing, and deicing utilizing the electro-thermal multilayer. The inventors have recognized that pulsed Joule heating can drastically reduce the required energy and time for frost/snow/ice removal in comparison with conventional steady Joule heating. The electro-thermal multilayer employed for heating, which includes a heating layer configured for electrical connection to a pulsed power source, may be self-supporting or may be supported by a substrate that is part or all of a component, such as an aircraft wing, a wind turbine blade, or a heat exchanger part. In examples where the electro-thermal multilayer is self-supporting, the electro-thermal multilayer may be employed as a standalone module or strip that can be removably attached to (e.g., secured to and optionally removed from) a component, such as a photovoltaic panel or an aircraft wing.

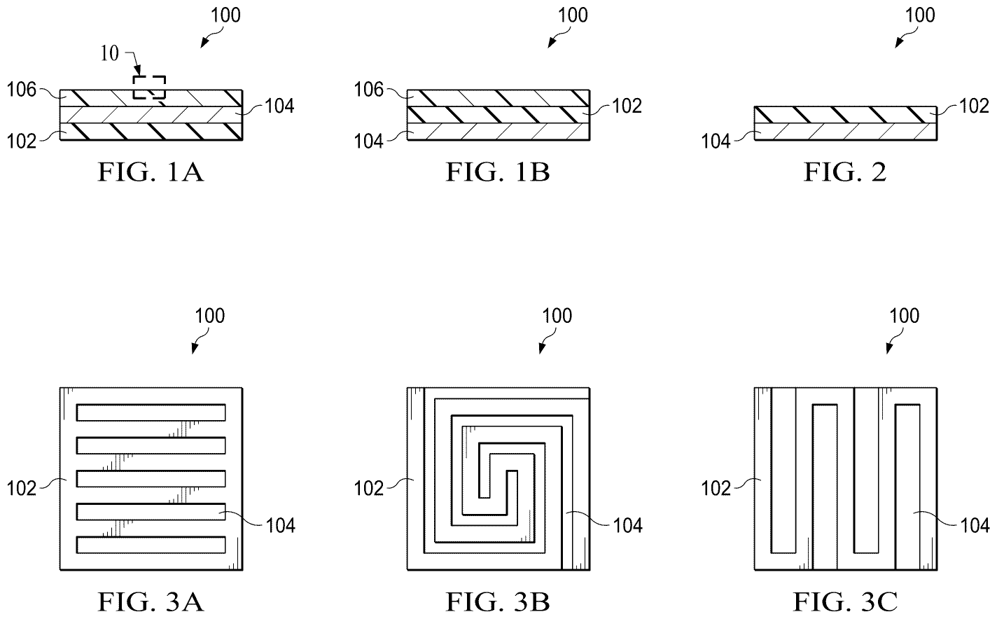

As shown in FIGS. 1A and 1B, an electro-thermal multilayer 100 includes a heating layer 102 on an insulating layer 104, and a superhydrophobic layer 106 on the insulating layer 104. As illustrated in the cross-sectional schematic of FIG. 1A, the heating layer 102 and the superhydrophobic layer 106 may be on opposing sides of the insulating layer 104; that is, the insulating layer 104 may lie between the superhydrophobic layer 106 and the heating layer 102. Alternatively, as illustrated in the cross-sectional schematic of FIG. 1B, the heating layer 102 and the superhydrophobic layer 106 may be on the same side of the insulating layer 104; more specifically, the superhydrophobic layer 106 may be positioned directly on the heating layer 102, and the heating layer 102 may be positioned directly on the insulating layer 104. In some applications, the superhydrophobic layer 106 may not be required. Accordingly, the electro-thermal multilayer 100 may alternatively include a heating layer 102 on an insulating layer 104, without the superhydrophobic layer, as shown in the cross-sectional schematic of FIG. 2.

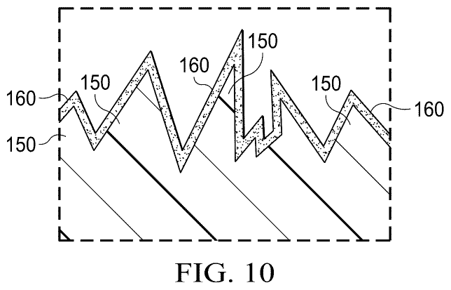

The heating layer 102 generates heat via pulsed Joule (or resistive) heating. The insulating layer 104 provides electrical and/or thermal insulation. The optional superhydrophobic layer 106 is highly repellant to water and facilitates rapid shedding of water droplets after melting occurs. As discussed below in regard to FIG. 10, the superhydrophobic layer 106 may combine nanostructures with a conformal hydrophobic coating to achieve superhydrophobicity, where water contacting the layer 106 exhibits an apparent contact angle of greater than 150° and a contact angle hysteresis of less than 10° (θₐ^{app}>150° and Δθ<10°).

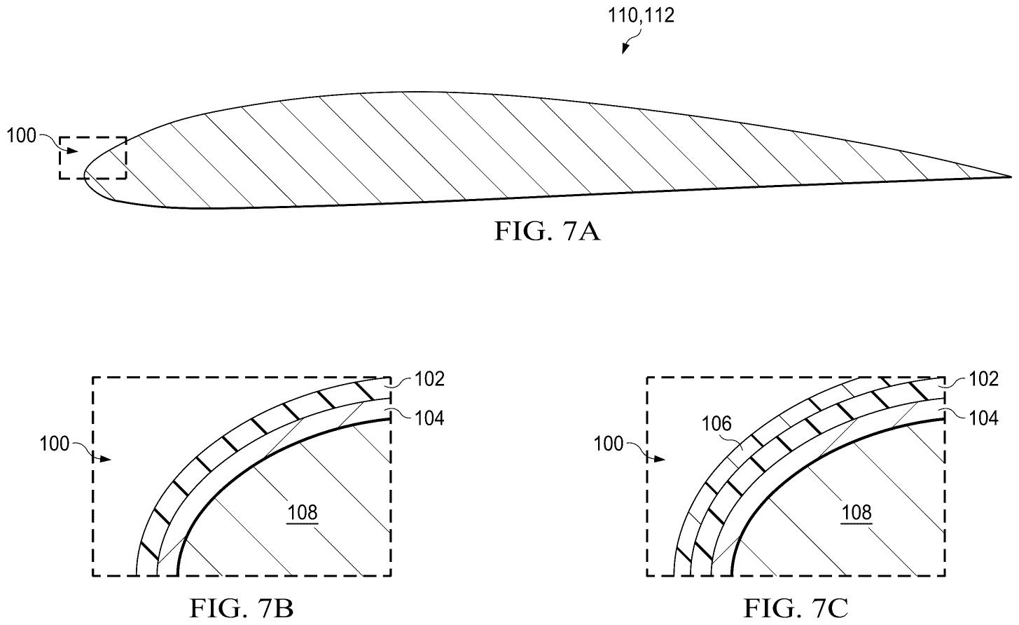

As indicated above, the electro-thermal multilayer 100 may be self-supporting. In such a case, one of the layers, typically the insulating layer 104, may function as a rigid or flexible substrate. This “substrate layer” may have a milli-or macroscale thickness that is much thicker than (e.g., an order of magnitude or more) the thickness of the other layers. For example, the insulating layer 104 may have a thickness greater than 1 mm and as large as 10 mm, or greater, whereas the heating layer 102 and the optional superhydrophobic layer 106 may have sub-milliscale (<1 mm) or sub-microscale thicknesses (e.g., <1 μm). In other examples, the electro-thermal multilayer 100 may be composed entirely of thin films that are supported by a substrate for use, as described below in reference to FIGS. 7A-7B. That is, each of the heating layer 102, the insulating layer 104, and the optional superhydrophobic layer 106 may take the form of a thin film, which typically has a sub-milliscale or sub-microscale thickness and which is applied to or deposited on a supporting substrate as a coating for use.

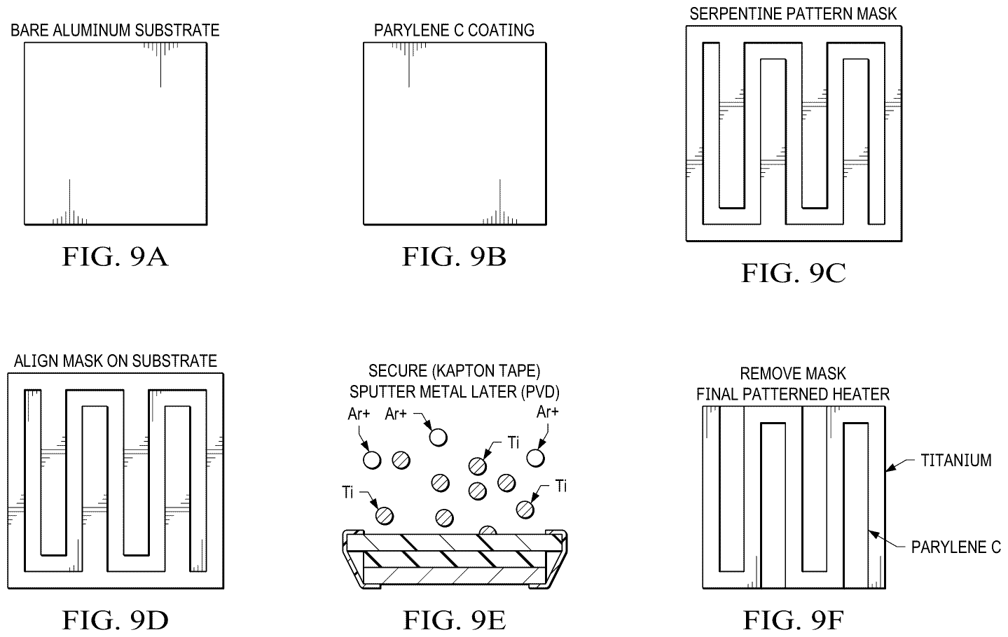

Advantageously, the heating layer 102 has a high thermal conductivity and moderate electrical resistivity, as desired for pulsed Joule heating, although preferably the layer is not so electrically resistive as to require an excessively high voltage. The heating layer 102 may take the form of a solid film or a patterned film 202, the latter of which is shown for example in the top-view schematics of FIGS. 3A-3C. Each patterned film 202 includes a surface area smaller than that of the insulating layer 104. The patterned film 202 may have any of a number of geometries, such as a grill geometry, as shown in FIG. 3A, a spiral geometry, as shown in FIG. 3B, or a serpentine or sinusoidal geometry, as shown in FIG. 3C. By utilizing a patterned film 202 instead of a solid film, the heating layer 102 comprises an electrically conductive “wire” having a reduced surface area and cross-section and an increased length for current flow. The patterned film 202 is so named since it may be formed by a patterning process, as shown for example in FIGS. 9A-9F and described below. Alternatively, the patterned film 202 may be formed by another method, such as 3D printing. It is understood that the electro-thermal multilayer 100 shown in FIGS. 3A-3C may optionally include a superhydrophobic layer 106 overlying the heating layer 102, as illustrated in FIGS. 1A and 1B.

Before further describing features of the electro-thermal multilayer 100, pulsed Joule heating, and the electrothermal method of defrosting, desnowing and deicing based on pulsed Joule heating, are explained.

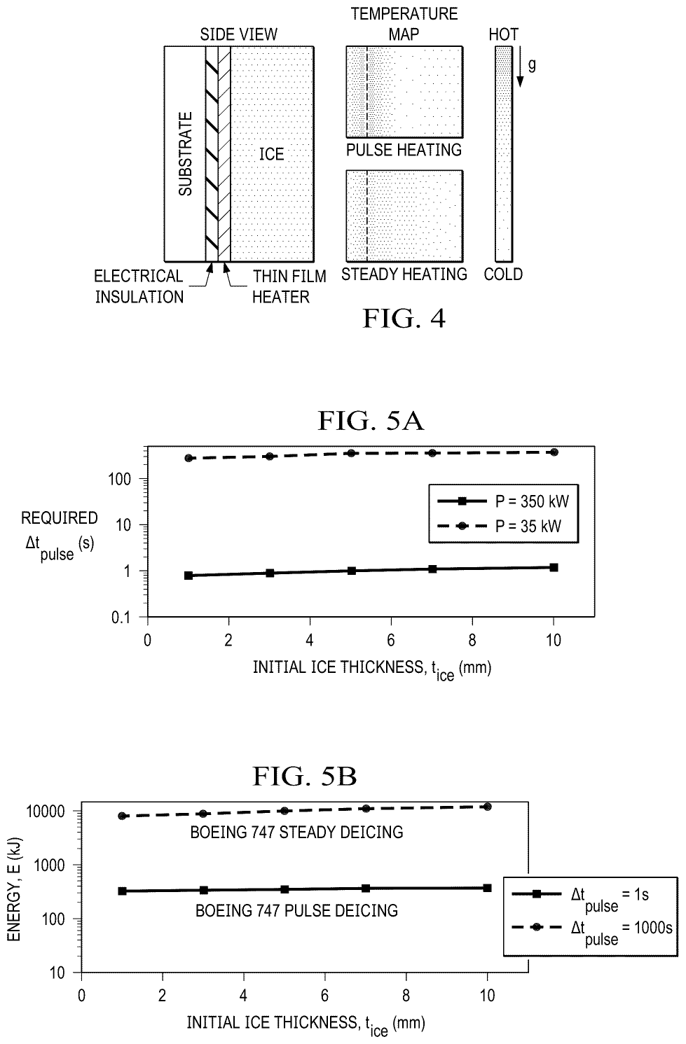

First, FIG. 4 shows a conceptual schematic to delineate the difference between pulsed Joule heating and steady Joule heating. For steady heating, the majority of input energy is wasted due to the diffusive nature of heat. During steady heating, which has timescales ranging from tens of seconds to several minutes, heat is allowed to diffuse into the snow/frost/ice as well as the substrate, resulting in needless sensible heating. Implementing a pulse of electro-thermal energy fundamentally reduces stray heat diffusion by confining the time allowed for heat transfer. This becomes clear by noting that the thermal diffusion distance (L_{diffusion}) in a solid media with no phase change scales with time (t) as L_{diffusion}˜(αt)^{1/2}, where a is the thermal diffusivity of the material. For pulsed Joule heating, the rapid and confined temperature rise near the heating layer may result in spontaneous melting of an ultra-thin region (<100 μm) of snow/frost/ice. The formation of the thin lubricating melted layer enables body forces such as gravity or shear to remove the remaining and un-melted snow/frost/ice.

A comparison of pulsed Joule heating with steady Joule heating to effect deicing of a wing of a Boeing 747 is illustrated in FIGS. 5A and 5B. FIG. 5A shows an estimate of the time required to remove ice from the aircraft using the pulsed Joule heating approach described in this disclosure compared to the estimated time for melting of the full ice layer. FIG. 5B estimates the energy and power required to melt the ice from the aircraft platform as a function of ice thickness for both steady and pulsed Joule heating. The results suggest that pulsed deicing requires approximately <1% of the energy required for steady deicing at lower power and longer times. Furthermore, the time to complete deicing with pulsed Joule heating may be only a fraction of the time (<10%) required to achieve deicing using the steady Joule heating approach.

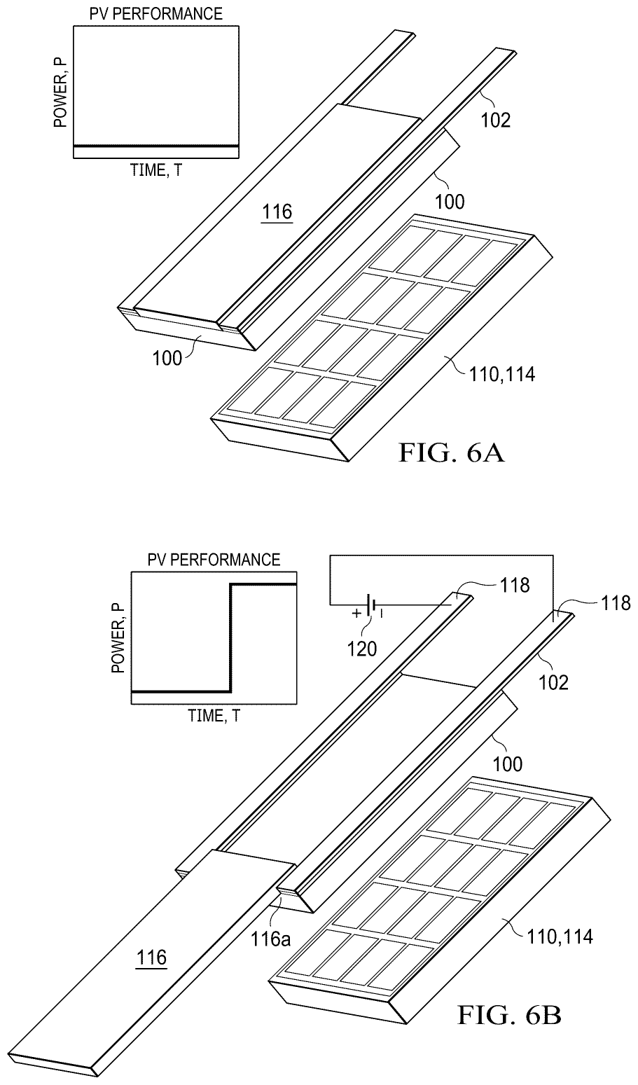

To carry out the pulsed heating method, a component 110, such as that shown in the exploded view of FIG. 6A, may be integrated with an electro-thermal multilayer 100 which includes a heating layer 102 on an insulating layer 104, as discussed above. In some examples, the electro-thermal multilayer 100 may further include a superhydrophobic layer 106, which can be positioned directly on the insulating layer 104 or directly on the heating layer 102, also as discussed above. The component 110 may used in renewable energy, thermal management, or aircraft systems, or in other applications. In the example of FIG. 6A, the component 110 is a photovoltaic panel 114. Alternatively, the component 110 may comprise an aircraft wing, a wind turbine blade, a heat exchanger part (e.g., a fin or coil) or another part.

In use, the component 110,114 is exposed to gravitational and/or shear forces. In FIGS. 6A and 6B, the gravitation force points vertically downward. Upon accumulation of frost, snow, and/or ice 116 on the component 110,114, an electrical pulse is applied to the heating layer 102 of the electro-thermal multilayer to induce rapid heating and thus interfacial melting of the frost, snow, and/or ice, such that a thin melted layer forms 116a. To form the melted layer, the electrical pulse may comprise a power density in a range from 1-10 W/cm². Referring to FIG. 6B (which also shows an exploded view schematic of the component 110,114 integrated with the electro-thermal multilayer 100), a power supply 120 electrically connected with the heating layer 102 via the electrical contacts 118 supplies the electrical pulse. The electrical pulse may be applied one time or multiple times. Typical pulse widths may lie in the range from 100 ms to 5 s. The resulting thin melted layer 116a lies either directly on the heating layer 102 or on one or more intervening layers (e.g., a superhydrophobic layer, a paint layer, an insulating layer, etc.) between the heating layer 102 and the frost, snow, and/or ice 116.

The thin melted layer 116a may function as a lubricating layer as described above, and sliding motion of the frost, snow, and/or ice 116 may occur in a direction determined by the gravitational and/or shear forces, allowing for removal of the frost, snow, and/or ice 116 from the component 110,114, as illustrated in FIG. 6B. As the frost/snow/ice 116 is removed, the photovoltaic panel 114 recovers electrical energy generation, as shown in the inset graph. For desnowing/deicing/defrosting of photovoltaic cells using pulsed Joule heating, the electro-thermal multilayer 100 is preferably or necessarily optically transparent, as discussed below. More generally speaking, the electro-thermal multilayer 100 integrated with the component 110 is capable of efficient pulsed surface heating and may also be superhydrophobic. Advantageously, the energy density utilized to remove the frost, snow, and/or ice is less than 10 J/cm².

The electro-thermal multilayer 100 used to illustrate the method in FIGS. 6A and 6B may be self-supporting and thus may be secured to the component 110 as a module, which in some examples may be removed from the component 110 at a later time if desired. Alternatively, the electro-thermal multilayer 100 may include thin films as discussed above and may therefore utilize the component 110 as a supporting substrate. In this example, the electro-thermal multilayer 100 may be applied to or coated on the component 110 using one or more thin film deposition methods, such as physical vapor deposition (e.g., sputtering, evaporation), chemical vapor deposition, sol-gel coating, dip coating, spin coating, and/or another coating method. This configuration is illustrated in FIGS. 7A-7C, where a substrate 108 that is part or all of a component 110 (in this example, a wing 112 of an electrified aircraft) supports the electro-thermal multilayer 100. The substrate 108 that supports the electro-thermal multilayer 100 may alternatively be part or all of a component 110 used in heat transfer, renewable energy, or another application.

FIGS. 7B and 7C show a portion of a leading edge of the aircraft wing 112 of FIG. 7A to illustrate two embodiments of the electro-thermal multilayer 100. As in the preceding examples, the electro-thermal multilayer 100 may include just the heating and insulating layers 102, 104 (FIG. 7B), or the electro-thermal multilayer 100 may further include a superhydrophobic layer 106 (FIG. 7C) to facilitate defrosting and desnowing, in addition to deicing, as discussed further below. It is noted that the majority of in-flight ice accretion on an aircraft wing may occur near the leading edge, where moist air first comes in contact with the cold airfoil surface and solidifies rapidly afterwards, and thus the leading edge is a region to target for pulsed Joule heating. The electro-thermal multilayer 100 may also or alternatively be applied to other portions of the wing 112, or to other components of the aircraft. The wing 112 shown schematically in FIG. 7A may comprise an aluminum alloy, and the insulating layer 104 visible in FIGS. 7B and 7C may function to prevent heat from being transferred to the aluminum alloy substrate 108 in addition to preventing current leakage to the substrate 108 during pulsed heating. Without the insulating layer 104, the power requirements could increase drastically due to the high electrical/thermal conductance of the aluminum alloy substrate 108, as discussed in the examples below. It is believed that the pulsed Joule heating approach described in this disclosure may be particularly advantageous for electrified aircraft, where electric motors replace internal combustion engines. Combustion gases that could be run through a heat exchanger and distributed through the aircraft skin to enable deicing are not available on electrified aircraft. Pulsed Joule heating may be facilitated due to the presence of electrical infrastructure, such as batteries, motor drives, cabling, and/or electrified powertrains on electrified aircraft.

The heating layer 102 may comprise any conductive material that can concentrate large quantities of heat in a small volume and can achieve heating uniformity. The conductive material may also or alternatively exhibit good reliability at high temperatures (e.g., a high melting point), corrosion resistance, and/or optical transparency. It is also preferred that the conductive material is readily available, low in cost, and easy to produce in the form of a film. The conductive material may exhibit a thermal conductivity in a range from 10 to 85 W/(m·K), for example, and/or an electrical resistivity in a range from 9 to 2000 μΩ·cm, for example. The conductive material may comprise a metal, a metal alloy, a conductive oxide, a carbon-based material, and/or a conductive polymer. Examples of suitable conductive materials include titanium, stainless steel, platinum, silver, gold, iron-chromium-aluminum alloy, nickel-chromium alloy (e.g., 80Ni-20Cr), copper-nickel alloy (e.g., 90Cu-10Ni or 70Cu-30Ni), indium-tin oxide (ITO), fluorine-doped tin oxide (FTO), aluminum-doped zinc oxide (AZO), gallium-doped zinc oxide (GZO), carbon nanotubes, graphene, and poly(3,4-ethylenedioxythiophene) (PEDOT). It is noted that large scale (>1 m²) sputtering and/or evaporation of conductive materials on various substrates (glass, polymers, metals, etc.) and various substrate geometries (flat, convex, and concave) is established and used in multiple industries. For some materials, such as indium-tin oxide and aluminum-doped zinc oxide, deposition may be carried out using sol-gel or solution-based coating methods, such as dip coating.

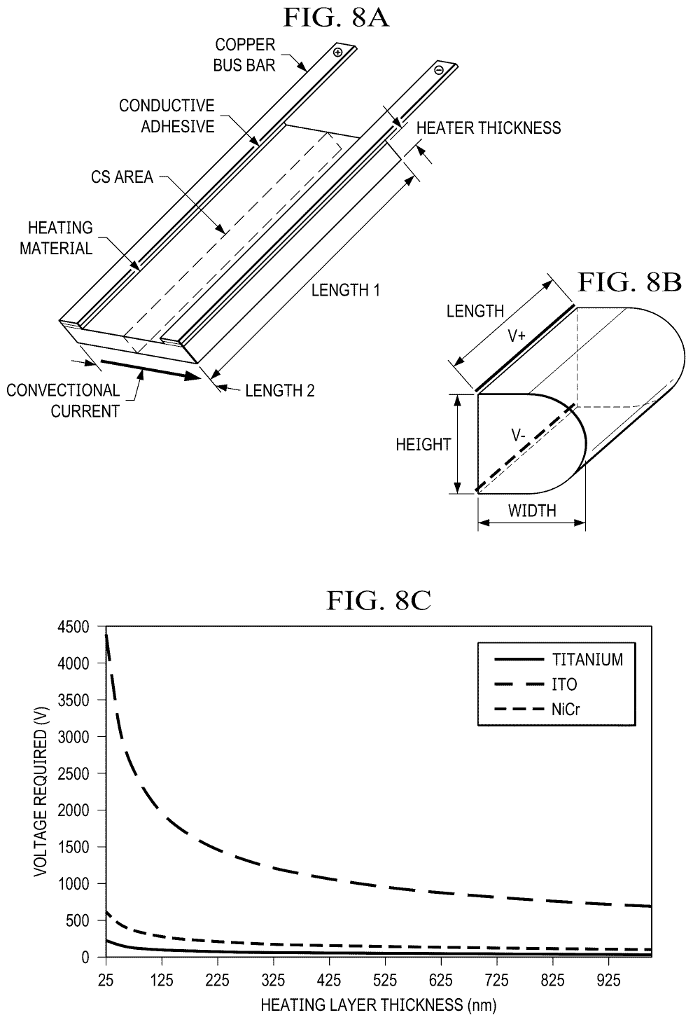

Investigations of a number of conductive materials, including titanium, ITO and nickel-chromium alloy (NiCr or Nichrome), as candidates for the heating layer 102 were carried out in an aircraft deicing study described in greater detail below. Titanium is believed to be advantageous due to its low voltage requirement, high thermal conductivity, low cost, ease of fabrication, and scalability. ITO has a high electrical resistivity, a reasonable thermal conductivity, optical transparency, and a well-established supply chain in the aviation industry. NiCr is widely implemented as a heating material, has low voltage requirements, moderate cost and resistivity values, can be readily fabricated and is highly scalable. In a preliminary analysis of deicing of a quarter wing leading edge according to the schematics shown in FIGS. 8A and 8B, where length 1 (L1)=1.23 m, length 2 (L2)=0.4897 m, surface area (SA=L1·L2)=0.6023 m², and power (P)=60.23 kW, titanium was found to be most cost effective with the lowest voltage burden, as can be seen in FIG. 8C, which plots the thickness of the heater layer versus the voltage required.

As indicated above, the heating layer 102 may take the form of a patterned film, as illustrated in FIGS. 3A-3C. An exemplary fabrication process involving sputtering with a mask having a serpentine pattern is illustrated in FIGS. 9A to 9F for an example in which titanium is employed as the conductive material for the heating layer 102, parylene is employed for the insulating layer 104, and the electro-thermal multilayer 100 is applied to an aluminum substrate 108.

For some applications, such as the photovoltaic panel 114 illustrated in FIGS. 6A and 6B, it may be beneficial for the electro-thermal multilayer 100 to be optically transparent. The electro-thermal multilayer 100, or an individual layer of the electro-thermal multilayer 100 (e.g., the heating layer 102), may be said to be optically transparent if at least about 90%, at least about 95%, or at least about 100% of incident visible light passes through the layer. To promote or ensure optical transparency, the thickness, composition, and/or arrangement of the layers of the electro-thermal multilayer 100 may be controlled. For example, the insulating layer 104 may comprise a transparent glass or polymer. The heating layer 102 and/or the superhydrophobic layer 106 may be constrained to a thickness of less than 100 nm and/or to a surface roughness of less than 30 nm. It may also be advantageous to apply the heating layer 102 and the superhydrophobic layer 106 to opposing sides of the insulating layer 104, as illustrated in FIG. 1A and as discussed in the examples below. The electrically conductive material of the heating layer 102 may comprise a transparent conductive oxide (e.g., indium-tin oxide (ITO), aluminum-doped zinc oxide (AZO) or gallium-doped zinc oxide (GZO)), carbon nanotubes, graphene, poly(3,4-ethylenedioxythiophene) (PEDOT), or metal nanowires or a metal mesh having high optical transparency. ITO in particular is a widely used transparent conductive material. Films based on carbon nanotubes may have the highest potential as an alternative to ITO due to their similar electrical conductivity (≈104 S cm⁻¹) and optical transparency.

The selection of the material for the insulating layer 104 is important as the maximum temperature during pulsing typically occurs in the insulating layer. The insulating layer 104 may comprise a polymer, a glass, an insulating oxide, such as silicon oxide or aluminum oxide, fiberglass, and/or anodized aluminum. A suitable polymer may comprise parylene, polydimethylsiloxane (PDMS), polyethylene terephthalate (PET), polyethylene naphthalate (PEN), or epoxy, for example. As discussed above in regard to FIGS. 7B and 7C, the insulating layer 104 may provide both electrical and thermal insulation for an underlying substrate 108. For some applications, when the electro-thermal multilayer 100 is used as a standalone module, the insulating layer 104 may function as both an electrical insulator and a rigid or flexible substrate for the electro-thermal multilayer 100.

The optional superhydrophobic layer 106 may include nanostructured surface protrusions 150 that have a hydrophobic species 160 attached thereto, as shown schematically in FIG. 10. The nanostructured surface protrusions 150 may comprise a metal oxide, or more specifically a metal oxide-hydroxide, such as aluminum oxyhydroxide, or boehmite (AlO(OH)). The nanostructured surface protrusions 150 may be formed by exposing a metal film to hot water (preferably hot deionized water) or a hot aqueous solution for a time sufficient for surface oxidation and roughening to occur. Typically, the exposure takes place for from 5 min to 75 min, and more typically from 5 min to 60 min. During the exposure, the hot water is typically maintained at a temperature in a range from 85° C. to 95° C. Typically nonuniform in size and shape, the nanostructured surface protrusions 150 may have a blade-like shape where the length of individual surface protrusions is greater than the width, which may be much greater than the thickness. The length of individual surface protrusions 150 is typically about 1 micron or less.

The nanostructured surface protrusions 150 may be rendered hydrophobic by surface modification (or functionalization) with the hydrophobic species 160. A chemical vapor deposition (CVD) process or another suitable method may be employed for surface functionalization. An exemplary CVD process may entail heating a solution of toluene and a hydrophobic species such as a silane (e.g., heptadecafluoro-1,1,2,2-tetrahydrodecyl trimethoxysilane (HTMS)) to a suitable temperature, such as 80° C. to 100° C. Typically, a volume ratio of the hydrophobic species to toluene in the solution is from 1:16 to 1:22. During the CVD process, the hydrophobic species 160 is deposited on the nanostructured surface protrusions 150. Deposition of the hydrophobic species 160 may take place over a period of typically two to four hours. The conformal hydrophobic coating, which may comprise a silane, is typically from a monolayer (>1 nm) to tens of nanometers (e.g., about 50 nm) in thickness. For example, the thickness may be from about 2 nm to about 10 nm, or from 2 nm to about 5 nm. The hydrophobic species 160 may deposit (or build up) uniformly and conformally over the nanostructured surface protrusions 150, and may create a rough surface having a Cassie wetting state that allows water or other liquid droplets to coalesce and jump off the surface. The hydrophobic species 160 may be understood to comprise a hydrophobic molecule or compound. As indicated above, the hydrophobic species 160 may comprise a silane, such as a methyl-silane, a linear alkyl-silane, a branched alkyl-silane, an aromatic silane, a fluorinated alkyl-silane, a dialkyl-silane, and/or heptadecafluoro-1,1,2,2-tetrahydrodecyl trimethoxysilane (HTMS). Water droplets may accumulate on the superhydrophobic layer 106 at reduced levels compared to an untreated heating layer 102, thus preventing frost formation or significantly reducing frost build-up.

The electro-thermal multilayer 100 may be part of a system that includes a pulsed power supply, which may comprise a battery or other energy storage device, and which may further include power electronics and cabling. The power requirements for pulsed deicing/defrosting/desnowing may be high and intermittent. In the example of aircraft implementation of pulsed Joule heating, it may be impractical to include a steady power delivery system sized for the maximum load onboard the aircraft. In this situation, it may be advantageous to utilize a pulsed power electrical energy storage module that can be re-charged at a slower rate during steady (non-pulse) operation. An investigation of candidate energy storage devices for aircraft deicing (e.g., supercapacitors, aluminum electrolytic capacitors, double layer capacitors, pseudo capacitors and hybrid Li-batteries, lithium-ion batteries) suggested that supercapacitors may be the most promising candidate.

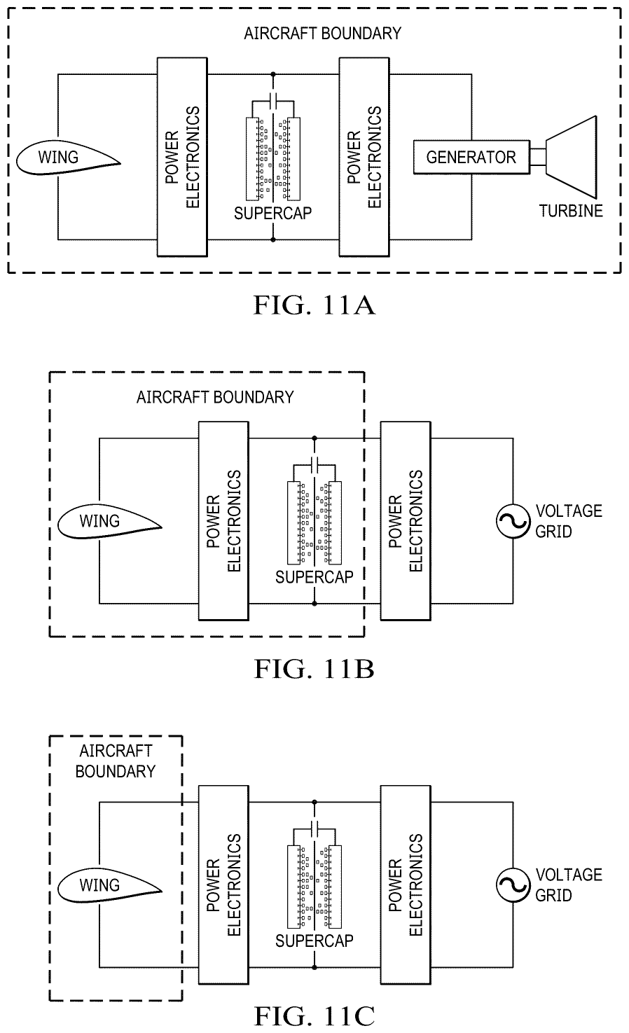

It is recognized that icing can occur on aircraft wings on-ground or in-flight. Depending on the scale of the aircraft and the cruising altitude, icing can be more prominent during in-flight operation as the temperatures are well below the freezing point with moisture content in the surrounding airflow. To enable in-flight deicing, the electrical infrastructure (e.g., power electronics, energy storage, cabling, the electro-thermal multilayer 100) may need to be integrated with the aircraft, as illustrated in FIG. 11A. Built-in electrified aircraft power sources may be employed to charge the energy storage device (e.g., supercapacitor), which can discharge the pulsed electrical power through the airframe to enable pulsed Joule heating and deicing.

In other situations, the supercapacitor or other energy storage device may be on-board of the airplane with the charging infrastructure on-ground, as illustrated in FIG. 11B. The supercapacitor can be charged prior to takeoff, with the device sized to enable multiple discharges over the course of the flight. The main difficulty with this strategy is that supercapacitors may not have the required power or energy density, making it difficult to deice the aircraft multiple times depending on the scale of the deicing system as well as the aircraft. Hence, a better method of deicing for multiple cycles may be to carry both a supercapacitor and a battery onboard the aircraft.

If only ground-based deicing is required, significant constraints on overall power density are removed as the aircraft does not have to carry the pulsed Joule heating infrastructure, as illustrated in FIG. 11C. The on-ground deicing strategy may keep on-ground energy storage devices (such as supercapacitors as shown) charged, so that whenever a flight is preparing for takeoff, the energy can be discharged to deice the aircraft. The on-ground deicing method can be used on stationary airplanes or on planes on the runway during takeoff prior to nose up. The advantage of takeoff deicing is that significant shear forces are present, which is not the case for stationary aircraft sitting idle on the tarmac, and thus the deicing efficiency may be higher with less power required.

For pulsed heating in a renewable energy application, such as for wind turbines or photovoltaic panels, the systems may be configured to be able to extract power from the electrical grid to which they are connected for a short time for pulsed defrosting or from a local energy storage device if the grid is unavailable. A PV panel array at the correct voltage and supplying enough current could potentially be used for direct pulsed heating. In other words, an existing and fully operational PV array could be used to defrost another PV array. Some topologies of wind turbine generators include a DC stage, but it may not be practical to link between turbines. It is worth noting that it may not be necessary to defrost all solar arrays or wind turbines at the same time. A more reliable strategy would be to defrost one turbine or solar array, and using the power from the recovered turbine or array, apply pulsed heating to other installations in the field. Conventional unidirectional inverters are only applicable to supply power to the electrical grid; therefore, a bidirectional inverter may be needed to redirect the power from the electrical grid or from a local energy storage device to the electro-thermal multilayer for pulsed heating.

### Example 1: Aircraft Application

In this work, a numerical simulation framework was developed to analyze the efficacy of pulsed Joule heating for aircraft deicing applications. As discussed above, pulsed deicing differs from conventional deicing approaches by melting only a thin layer of ice with a high energy pulse which is spatially and temporally confined to the substrate-ice interface. The thin melt layer reduces the adhesion between the ice/wing interface, allowing aerodynamic forces to remove the bulk ice from the wing without melting.

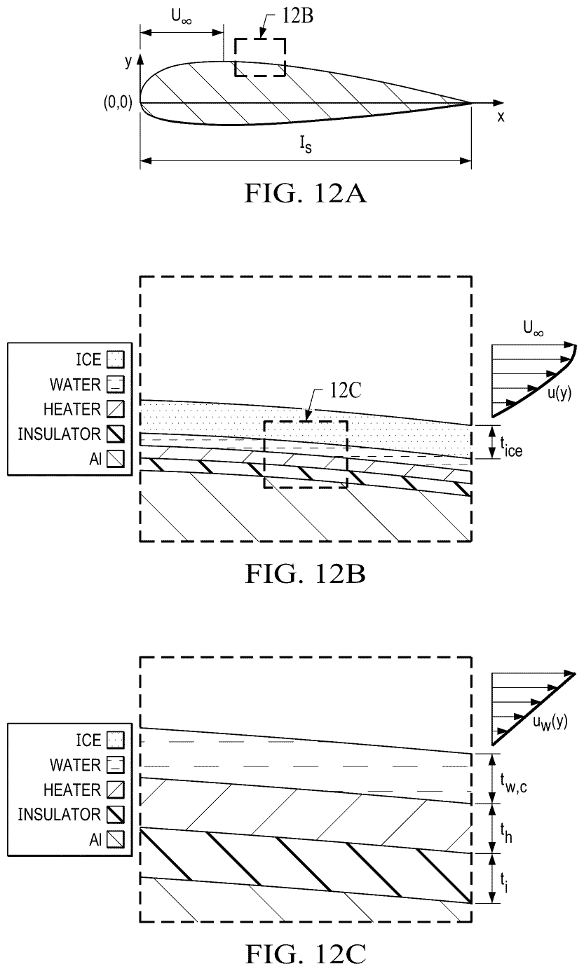

A 2D finite difference method simulation was developed to determine the power requirements for pulsed deicing. The model couples the hydrodynamics of melt layer formation and ice removal with the thermodynamics and heat transfer of phase change (melting and refreezing), and the local shear rate on the ice material due to boundary layer formation on the aircraft. Referring to FIGS. 12A-12C, an exhaustive analysis of various parameters on deicing performance was carried out considering substrate electrical insulating layer thickness (10 μm<tᵢ<1 mm), heating layer thickness (50 μm<tₕ<1 mm), material electrical and thermophysical properties, pulse duration (200 ms<Δtₚᵤₗₛₑ<4.2 s), air speed (100 m/s<U_{∞}<500 m/s), and aircraft size (1 m<S<16 m). Deicing performance was analyzed with respect to system volumetric and gravimetric power density. All design parameters were selected based on aircraft platform scale, mainly focusing on the Boeing 747, Embraer 175 and Cessna 172 airframes. The simulation results demonstrate that pulsed electro-thermal deicing is a more feasible method for modern more-electric aircraft than conventional deicing methods, demonstrating five times higher efficiency with time reduction to deice the surface.

### Model

Electro-thermal deicing aims to remove all ice adhered to the aircraft. A certain amount of pulsed energy is required for complete deicing and to prevent runback. In the simulations, a single electro-thermal multilayer is placed on the aircraft wing and the effects of runback during deicing are considered. The electrothermal multilayer includes, on the aluminum (Al) aircraft wing, an insulating layer used to prevent thermal and electrical conduction to the Al substrate and confine the energy to the heater/ice interface (e.g., paint), and the heating layer connected to the electrical circuit to provide the pulsed heating.

Due to the presence of a thin film heating layer with an insulating layer beneath it, all electrical and the majority of thermal energy is directed to the ice formed on the aircraft wing. Due to pulsed energy input, heat is spatially and temporally confined, resulting in heating of only a fraction of ice near the heater/ice interface. The thin melt layer reduces adhesion between the ice and heating layer. The time-dependent thickness of the melt water layer (t_{w,c}) is important as it can dictate the rate at which ice can flow (shear) over the aircraft wing. To model the transient hydrodynamics of the water melt layer, a fully developed Couette flow profile in the water layer after pulsing (u_{w}(y), FIG. 12C) is assumed. The model does not consider effects of the curvature of the aircraft wing due to the thickness of the melt layer (˜100 μm) being much smaller than the radius of curvature of the airfoil profile (˜1 m). To take into account the effect of shear force due to airflow on the top ice surface during deicing, the developing boundary layer flow along the aircraft wing is considered as a function of aircraft speed (U_{∞}, FIG. 12C). To account for the boundary layer flow, the velocity profile (u(y), FIG. 12B) along the wing surface is considered as a function of location, which results in a spatially dependent shear rate.

To model the thermal phenomena present during pulsed heating, a finite difference method model was developed that incorporates two separate hydrodynamic sub-models to take into account the local air flow boundary layer shear effects, and the time-dependent melt layer lubrication dynamics. To model the heat transfer, the 1D time dependent energy equation is used within the domains of interest.

In the solution of the phase change problem, the enthalpy form of the energy equation (Eq. 1) is equivalent to the classical temperature form in which the heat equation is written separately for the liquid and solid regions and coupled by an energy balance at the solid-ice/frost interface. Hence, the governing equations for solid and liquid phases need not be separated, and can be represented as:

$$ρ \frac{\partial h}{\partial t} = k \frac{{\partial }^{2} T}{\partial {y}^{2}} + \dot{q} , \qquad ( 1 )$$

where ρ, h, and k are the are the density, enthalpy, and thermal conductivity, respectively, t is time, \dot{q} is the volumetric heat generation, T is local temperature, and y is the distance in the domain along the thickness of the aluminum substrate as defined in FIGS. 12A-12C. To solve Eq. (1), we use the finite difference approximation in space and time using the implicit scheme.

$$ρ \frac{{h}_{i}^{n + 1} - {h}_{i}^{n}}{Δ t} = k \frac{{T}_{i - 1}^{n + 1} - 2 {T}_{i}^{n + 1} + {T}_{i + 1}^{n + 1}}{Δ {y}^{2}} + \dot{q} , \qquad ( 2 )$$

where the subscript i denotes spatial discretization and the superscript n denotes time discretization. At every time step, a guess temperature, T*(y, tₙ₊₁), equal to the temperature solution obtained from the previous time step, T*(y, tₙ₊₁)=T(y, tₙ) is assumed. The Taylor series approximation of enthalpy as a function of temperature at the current time step (tₙ₊₁) is used:

$$h ( {T}_{i}^{n + 1} ) = {h}^{*} + {( \frac{\partial h}{\partial T} )}^{*} ( {T}_{i}^{n + 1} - {T}_{i}^{*} ) , \qquad ( 3 )$$

where ‘*’ indicates a parameter evaluated based on the best guess for temperature. Substituting Eq. (3) into Eq. (2) results in a discrete equation for the interior cells:

$$[ {( \frac{\partial h}{\partial T} )}^{*} + \frac{2 k Δ t}{ρ Δ {y}^{2}} ] {T}_{i}^{n + 1} = \frac{k Δ t}{ρ Δ {y}^{2}} ( {T}_{i - 1}^{n + 1} + {T}_{i + 1}^{n + 1} ) + {h}_{i}^{n} + {( \frac{\partial h}{\partial T} )}^{*} {T}_{i}^{*} - {h}^{*} + \frac{Δ t \dot{q}}{ρ} . \qquad ( 4 )$$

$$h = \{ \begin{matrix}{C}_{p . i} T & T \leq {T}_{sol} \\ \begin{matrix}( \frac{{T}_{liq} - T}{{T}_{liq} - {T}_{sol}} ) {C}_{p , i} T + \\ ( \frac{T - {T}_{sol}}{{T}_{liq} - {T}_{sol}} ) {C}_{p , i} T + ( \frac{T - {T}_{sol}}{{T}_{liq} - {T}_{sol}} ) L\end{matrix} & {T}_{sol} < T < {T}_{liq} \\ L + {C}_{p , w} T & T \geq {T}_{liq}\end{matrix} , \qquad ( 5 )$$

where C_{p,i} and C_{p,w} are the heat capacities of ice and water respectively, T_{liq} and Tₛₒₗ are the liquidus and solidus temperature, L is the latent heat, Δt and Δy are the time and space discretizations respectively. The boundary conditions used are:

$${\frac{\partial T}{\partial y} \vert}_{y = 0} = 0 , \qquad ( 6 )$$

$${- k \frac{\partial T}{\partial y} \vert}_{y = {t}_{s} + {t}_{i} + {t}_{h} + {t}_{i c e}} = {\overline{U}}_{ice - ambient} [ T ( {t}_{s} + {t}_{i} + {t}_{h} + {t}_{ice} , t ) - {T}_{a} ] , \qquad ( 7 )$$

where tₛ is the distance between the camber line (FIG. 12A) and the aluminum wing surface (half of the substrate thickness), tᵢ is the insulator thickness, tₕ is the heater thickness, t_{ice} is the initial ice thickness, Tₐ is the ambient temperature (Tₐ=−15° C.), and Ū_{ice-ambient} is the heat transfer coefficient to the ambient estimated depending on the air speed (Ū_{ice-ambient}=20 W/(m²·K) and 200 W/(m²·K) for stationary and flying aircraft, respectfully) using the boundary layer equations for flow over a plat plate with length approximated by the wing camber line. The initial condition is:

$$T ( y , t = 0 ) = - 15 ° C . , \qquad ( 8 )$$

The solution to the thermal energy equation (t_{w,c}) is then substituted into the following dynamic equation:

$${ρ}_{i} ( {t}_{i c e} - {t}_{w , c} ) \frac{{d}^{2} x}{d {t}^{2}} = {ρ}_{i} ( {t}_{i c e} - {t}_{w , c} ) a - \frac{μ}{{t}_{w , c}} \cdot \frac{d x}{d t} , \qquad ( 9 )$$

where t_{w,c} represents the melted ice thickness, x is the position of the ice block, μ is the dynamic viscosity of water, a is the acceleration due to shear force on the ice-block, and x is the direction along the chord length of the wing. The melt dynamic equation (Eq. 9) is coupled to the thermal energy solution in the solid ice region only. At every time step we calculate the thickness of ice melted by calculating where the temperature in the ice layer exceeds the melting point, which is then substituted into Eq. (9) to update the position variable at that time-step.

The aim of pulsed deicing is to remove all ice from the aircraft wing. This may be achieved when the position of the ice is greater than the length of the wing (x>Iₛ). This condition is coded into the model as the stopping condition. The material properties of the various layers and of water and ice are first initialized (Table 1). These properties are then substituted into the model which runs for pulsing times ranging from 200 ms to 4.2 s with a pulsed time steps of 0.2 s. A power is then initialized which is incremented if the thermal solution does not remove the ice from the aircraft wing for the specified amount of power input. The thermal finite difference code is run until a converged temperature profile is achieved, as measured by a residual less than 10⁻⁴. The solution is then substituted into the dynamic finite difference equation (Eq. 9) which calculates the position of the ice-block at every time step. After the updated position is calculated, it is fed into the condition check for complete removal of ice at every time step. If the ice removal condition is met, the simulation is stopped, the power supplied for that particular pulsing time is registered and the pulsing time is incremented. If however, the ice-removal condition is not satisfied, the simulation moves to another condition which checks whether all of the time steps for the current power-pulse time combination have been exhausted. If true, the power input to the heater is increased. If false, the simulation moves to the next time-step. This iteration continues for every pulse time from 200 ms to 4.2 s. The numerical code outputs an array of required power and energy for a particular size of aircraft and other material properties. A detailed list of the common input parameters used in the simulation are shown in Table 1.

TABLE 1
Parameters used in the simulations.

| Parameter | Symbol | Range |
|---|---|---|
| Pulse times | Δtₚᵤₗₛₑ | 0.2 s to 4.2 s |
| Insulator thicknesses | tᵢ | 0.01 mm to 1 mm |
| Insulator thermal conductivity | kᵢ | 0.4 W/(m · K) to 1 W/(m · K) |
| Heater thickness | tₕ | 0.05 mm to 1 mm |
| Heater thermal conductivity | kₕ | 10 to 85 W/(m · K) |
| Air speed | U_{∞} | 100 m/s to 500 m/s |
| Aircraft wing size (chord length) | lₛ | 1 m (Cessna 175) |
| | | 2 m (Embraer 172) |
| | | 5 m (Boeing 747) |

To calculate the forces acting on the ice-melt layer, the shear stresses due to the air flow over the wing are analyzed (FIG. 12B). The shear stress is characterized by the local skin friction coefficient (C_{f,x}). The skin friction coefficient is highly dependent on the regime of air flow across the airfoil (laminar or turbulent), the shape of the airfoil, the properties (temperature and pressure) of the air, and the surface roughness. Hence, it is difficult to derive a closed form solution that can predict most cases. Given the wide parameter space as well as possible airfoil geometries, numerical simulations are used to determine how C_{f,x} varies along the airfoil. Here, it is assumed that the amount of ice accumulated on the wing is uniform (FIG. 1B) and is thin and smooth enough not to disrupt the boundary layer development as characterized on an ice-free wing surface. The commercial tool XFOIL is used to obtain C_{f,x}. The NACA 12 airfoil profile is selected as it represents one of the most studied airfoils in the past. To model the appropriate flow regimens, air flow Reynolds numbers Reₗ=(ρₐU_{∞}l)/μₐ ranging from 2×10⁶ to 2×10⁷ are used (where l is the average chord length, and ρₐ and μₐ are the free stream density and dynamic viscosity, respectively), typical for modern aircraft. The maximum number of iterations was set to 600 to obtain convergence in XFOIL. As the shear force acts on the solid ice block, which is modeled as rigid body motion along the wing surface (Eq. 9), the local skin friction coefficient is averaged to obtain a surface-averaged skin friction coefficient (C_{f}) for the entire airfoil:

$${C}_{f} = \frac{1}{l} {\int }_{0}^{1} {C}_{f , x} dx , \qquad ( 10 )$$

The averaged shear stress (τ) is then calculated using:

$$τ = \frac{1}{2} {ρ}_{a} {U}_{rel}^{2} {C}_{f} , \qquad ( 11 )$$

where Uᵣₑₗ is the relative velocity between the sliding ice sheet and air free stream velocity (U_{∞}). The velocity of the sliding ice sheet (U) was calculated at every time-step using a backward difference scheme from the positions calculated. The free stream air velocity was assumed to be constant and was varied to study the effect of flow regime on pulsed deicing. The calculated shear force (Eq. 10) was then used for the next time-step update until it was reassigned.

### Results and Discussion

To develop design guidelines and a comparison with state-of-the-art deicing techniques, the developed model was used to study the effects of the various parameters (Table 1) on pulsed deicing performance.

### Effect of Insulator Material and Thickness (tᵢ)

The insulator (FIG. 1) is located between the heater and the Al substrate. The insulator functions to prevent heat from transferring to the Al substrate in addition to preventing current leakage to the Al substrate during pulse heating. Without the insulator, the power requirements increase drastically due to the high electrical/thermal conductance of the Al substrate. The insulator materials considered here were either a polymeric/epoxy layer (paint) or fiberglass. The selection of insulator material is important as the maximum temperature during pulsing typically occurs in the insulator. Also, most of the temperature gradient occurs across the insulator because of its low thermal conductivity. There is little temperature gradient across the aluminum substrate which demonstrates that there is no heat flow going through it. On the other hand, for the case with no insulator tᵢ=0 mm, a significant temperature gradient across the aluminum substrate may be observed, implying appreciable heat flow through it. Hence, good thermophysical properties at elevated temperatures are important.

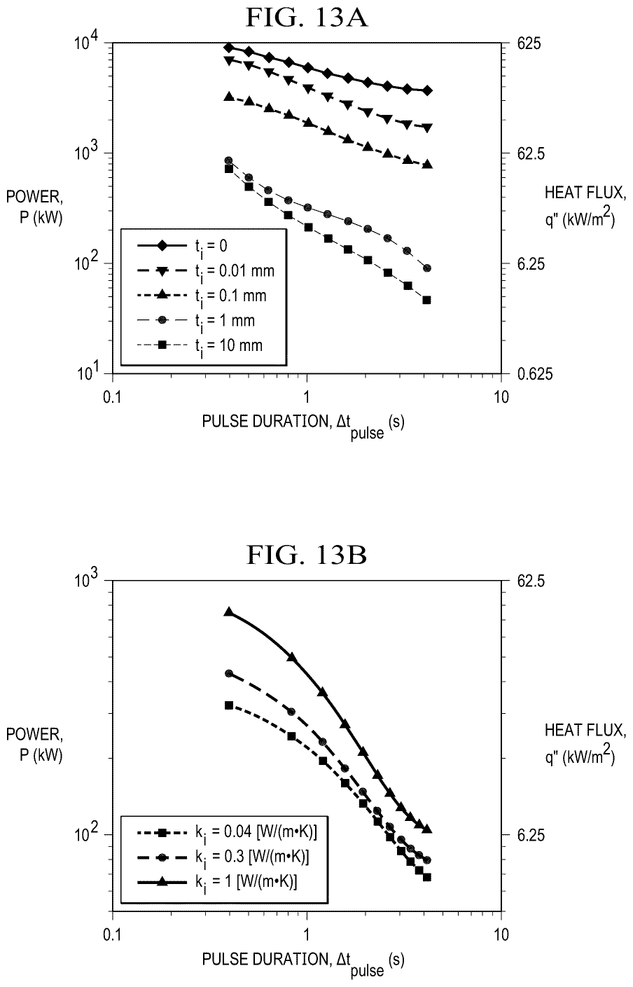

FIG. 13A shows the required pulse power (P, left axis) input and heat flux (q″, right axis) as a function of pulse time (Δtₚᵤₗₛₑ) for five different polymer insulator thicknesses having thermal conductivity of kᵢ=1 W/(m·K). The simulation assumes a heater material thickness tₕ=100 μm and a cupro-nickel (70-30) heater material. Insulator material thickness plays an important role. Larger insulator thicknesses lead to lower power requirements as thermal energy is more easily directed into the ice due to the increased thermal resistance to the back side (˜tᵢ/kᵢ). However, the sensitivity to thickness dampens as the thickness continues to increase due to the insulator back side resistance becoming dominant. Further increases of insulator thickness beyond this point (>1 mm) are impractical. As expected, the pulse power required decreases as the pulse time increases due to the loss of spatial confinement of energy required for melting ice at the heater/ice interface.

To investigate the effect of insulator material thermophysical properties, the insulator intrinsic thermal conductivity (kᵢ) was varied within a range of common insulator materials ranging from polymers to fiberglass having a fixed insulator thickness of tᵢ=1 mm. The majority of available materials have thermal conductivities ranging from 0.4 W/(m·K)<kᵢ<1 W/(m·K). Analogous to insulator thickness, decreasing the insulator thermal conductivity results in decreased pulsed power required for deicing (FIG. 13B). For the pulse timescales considered here (Δtₚᵤₗₛₑ>0.2 s), the thermal penetration depth (˜(αt)^{1/2}) exceeded the insulator thickness for all cases, resulting in clear differentiation of the deicing results based on both insulator and substrate materials.

### Effect of Heater Material Selection and Heater Thickness (tₕ)

The heater material represents the main Ohmic resistance through which the pulsed electrical energy is converted to heat at the wing surface. A wide variety of thin film heater materials are available, and hence, a comprehensive analysis is required to select the best material for pulsed deicing. The key factors to be considered include material and manufacturing cost, melting point, thermal conductivity, scalability, and electrical resistance (R). The electrical resistance directly governs the voltage requirement (V) needed from the power source in order to supply the required pulse power (P). The supply voltage is a key consideration as electrical storage devices are available only for a range of output voltages and are not arbitrary. The voltage, electrical resistance, and power are related by:

$$P = \frac{{V}^{2}}{R} . \qquad ( 12 )$$

The melting points of the majority of heater materials considered here (Table 2) are relatively high (>500° C.) and hence, melting does not represent a constraint for pulsed deicing within the parameters studied here. To obtain a conservative estimate of the high voltage requirements, the pulse voltage was calculated for a P=1 MW power delivery system representing the highest amount of electrical power on a commercial more electric aircraft (Boeing-747). The values of all calculated parameters for various heater materials are summarized in Table 2. This analysis revealed that the most important characteristics which affect the power requirement (P) are the heater thermal conductivity (kₕ) and the thickness of the heater (tₕ).

TABLE 2
Summary of available thin film heater materials and their
thermophysical and transport properties for aircraft pulsed deicing
applications. The dimensions considered for the power requirement
calculation correspond to a Boeing-747 aircraft (A = 16 m²).
Voltage requirement was calculated based on P = 1 MW. Cu—Ni, ITO,
and FTO stand for cupro-nickel, indium-tin oxide, and
fluorine-doped tin oxide, respectively.

| | Melting | | | Electrical |
|---|---|---|---|---|
| | Point | Relative | kₕ | Resistivity |
| Material | [° C.] | Cost | [W/(m · K)] | [μΩ · cm] |
| Nichrome [44] | 1400 | Cheap | 11 | 40 |
| Kanthal [45] | 1500 | Cheap | <11 | 145 |
| Cu—Ni (90-10) [46] | 1100 | Cheap | 59 | 19 |
| Cu—Ni (70-30) [46] | 1200 | Cheap | 25 | 37.5 |
| Platinum (Pt) [47] | 1768 | Expensive | 78 | 10.5 |
| ITO [48] | 1400 | Expensive | 10 | ≈2000 |
| FTO [49] | 1630 | Expensive | 9.6-16 | ≈1000 |

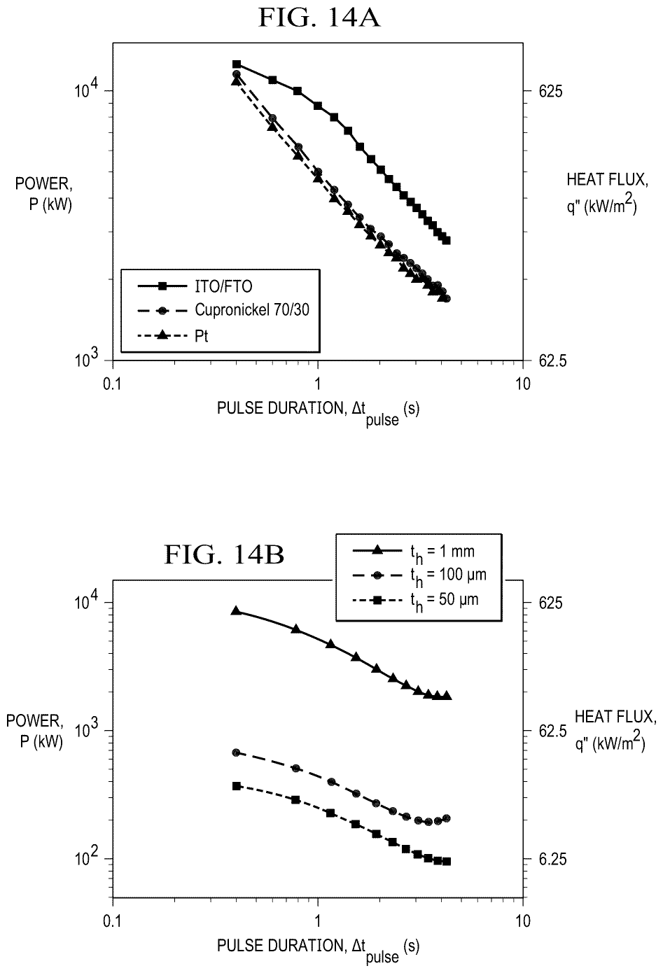

The power requirement as a function of heater thermal conductivity (kₕ) is quite apparent from the simulation results. FIGS. 14A and 14B show the variations of required power for pulsed deicing as a function of time for a subset of heater materials summarized in Table 2. As kₕ reduces, the power requirement increases. The higher power required arises because the heater material itself works as an added thermal resistance to heat flow to the heater-ice interface. This thermal resistance is unavoidable and hence, thermal energy is lost to additional required specific heating of the heater material to establish a larger temperature gradient to drive heat to the ice, resulting in more heat lost to the back-side substrate as well. As the thermal resistance is inversely proportional to the thermal conductivity, more energy is lost for lower thermal conductivities of the heater material. Although realistically, high thermal conductivity materials typically have low electrical resistivity, the low resistance adversely affects the voltage requirement of the energy source (Table 2). Hence, a trade-off analysis is required to identify an optimal conductive material with high intrinsic thermal conductivity with a reasonably low electrical resistivity. Based on the materials analyzed, cupro-nickel (Cu—Ni(70-30), Table 2) presents a good candidate based on voltage requirements and hence, is chosen for the remainder of this study.

In addition to intrinsic heater thermal conductivity, a key heater geometric parameter is the selected heater thickness. As the power provided is constant during the pulse, the power density increases as we decrease the heater thickness. The increased power density drastically increases the wall temperature of the heater material, altering the deicing mechanism. A high-power density is advantageous to achieve melting of the ice and hence reduces the power required (P) during the pulse. However, the electrical resistance (R) of the heater material must be considered as it is dependent on the heater thickness. Hence, if heater thickness is reduced, R increases, further increasing the required voltage (Eq. 12) to a point of impracticality.

### Effect of Air Speed (U_{∞}) and Aircraft Size

Airflow is a key factor in deciding the power requirement for deicing as the air shear is the main mechanism which carries the ice away from the wing after heating. The air speed (U_{∞}) becomes particularly important for pulsed deicing applications as only a thin layer of ice close to the substrate is melted, requiring rapid removal prior to re-freezing of the melt layer. During flight at typical altitudes (10,000 m), the air is generally calm and hence most of the air speed can be attributed to the speed of the aircraft itself. The aircraft studied here have typical cruising speeds ranging from 100 m/s to 500 m/s. From a simplified theoretical standpoint, the effect of air speed can be understood in terms of the variation of shear force with the airfoil speed. For turbulent flows (10⁵<Reₗ<10⁸):

$${C}_{f} ∼ {( {log}_{10} R {e}_{l} )}^{- 2.58} , \qquad ( 13 )$$

According to Eq. (11), the shear force varies with the product of C_{f} and the square of the relative velocity (Uᵣₑₗ). As it is assumed that the air during flight is quiescent, the relative airspeed becomes equivalent to the aircraft speed (Uᵣₑₗ=U_{∞}). As the relative velocity increases, the shear force on the ice-melt layer increases, and hence the ice can be removed at a faster rate, helping to reduce the power required to achieve deicing. Physically, the required thickness of the melt layer reduces due to the lower ice residence time for larger shear forces stemming from faster ice acceleration (Eq. 9) and hence removal. As discussed previously, XFOIL was used to obtain an accurate value of C_{f} for the NACA 12 airfoil used in our numerical code.

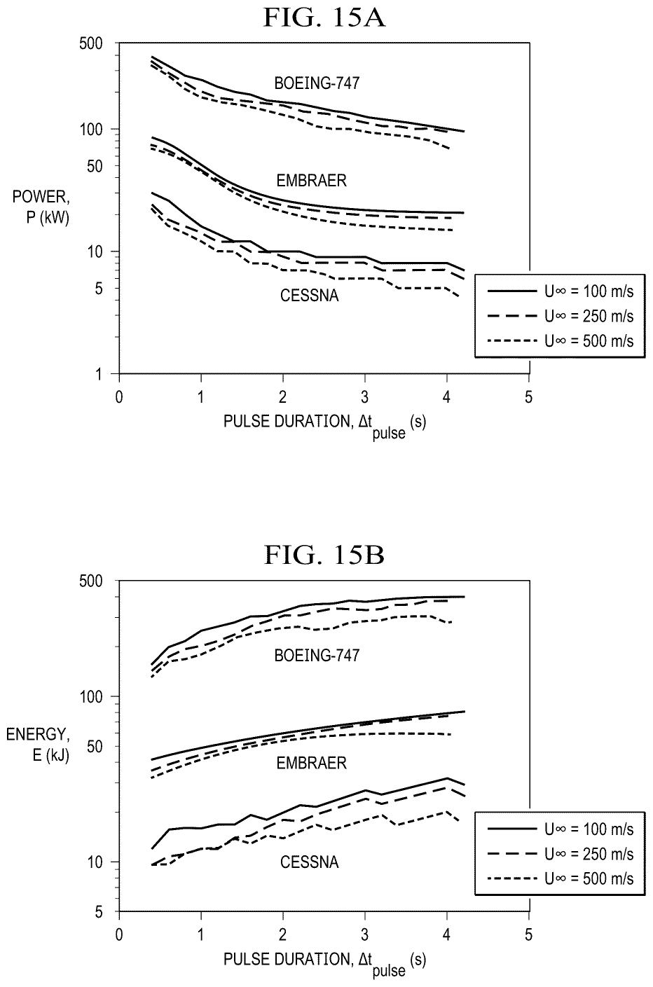

FIGS. 15A and 15B plot the energy (E) and power (P) required as a function of pulse time (Δtₚᵤₗₛₑ) for various aircraft length scales with tᵢ=1 mm, kᵢ=1 W/(m·K), tₕ=100 μm, with a cupro-nickel (Cu—Ni (70-30), Table 2) conductive material. In terms of aircraft size, the power required for deicing increases with increasing airframe size as more ice interface needs to be melted, as shown in FIG. 15A. However, the relationship between power and aircraft size is non-linear as the ice also refreezes at later stages (runback). Chances of runback are higher for large airplanes due to the longer residence time of ice and meltwater on the airframe during pulsed deicing (Eq. 9), hence the power requirement increases non-linearly.

The variation of energy required (E) during pulsed deicing as a function of pulse time (Δtₚᵤₗₛₑ) is also non-linear (FIG. 15B). The energy required for deicing decreases as Δtₚᵤₗₛₑ decreases. This is because lower Δtₚᵤₗₛₑ reduces parasitic heat losses and enhances confinement of heat only to the melt layer, reducing the total energy required. However, once a lower threshold of Δtₚᵤₗₛₑ is reached, E begins to increase due to the limited thermal penetration depth of the pulse. At very short Δtₚᵤₗₛₑ (<100 ms), the thermal penetration front does have the required time to travel large enough distances into the ice layer to enable melting, resulting in vanishingly thinner ice-melt layer thickness. The thinner ice-melt layer in turn increases the Couette-flow resistance to the motion of ice along the airfoil and hence the energy requirement increases. Although electronics generating pulses of the order of 10 ns have been demonstrated, they are not considered here due to the high energy and power requirements at such timescales, limiting our analysis to pulses on the order of 100 ms.

### Temperature of the Insulating Layer

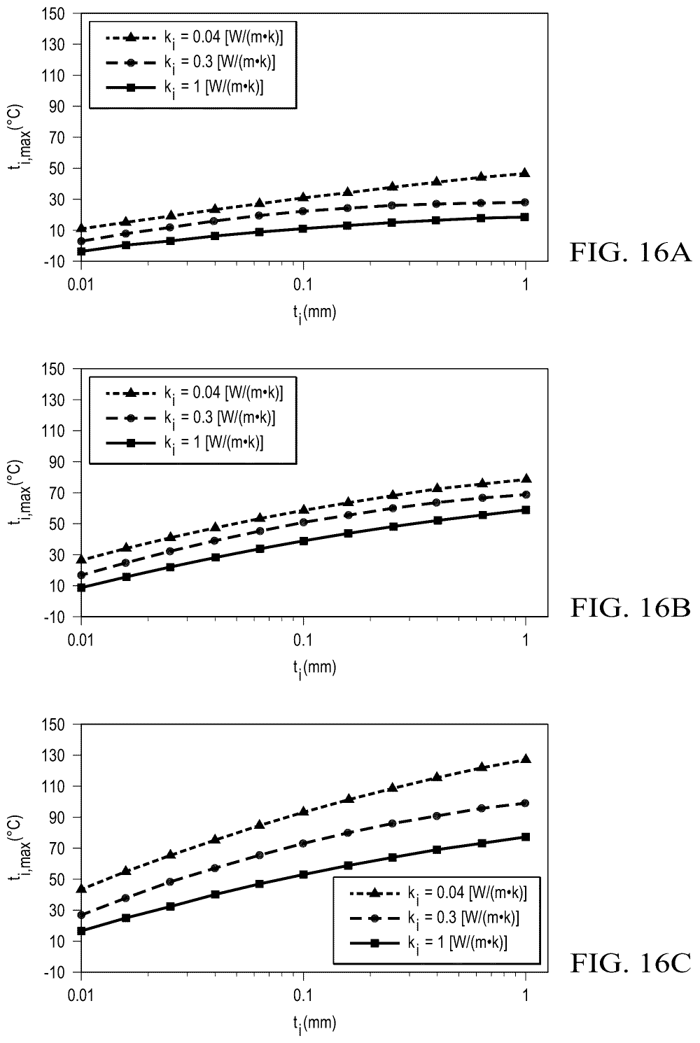

The transient temperature response across the electro-thermal multilayer during pulsed deicing is a key analysis parameter due to the need to avoid material degradation such as melting, thermal fatigue, and creep. The simulations show that the highest temperatures typically occur at the heater-insulator interface as it is closest to the heater layer and has a lower thermal conductivity in order to confine the heat and direct it to the ice. Analysis of the pulse operation enabled plotting of the maximum temperatures in the insulator layer (T_{i,max}) as a function of insulator thermal conductivity (kᵢ) and thickness (tᵢ) for a Cessna-172, Embraer-175, and Boeing-747 aircraft wing, as shown in FIGS. 16A-16C, respectively. The majority of insulator materials considered here have melting points greater than 220° C. Hence, the results demonstrate that the insulator materials are well within the limits for pulsed de-icing applications for the conditions (pulse times and powers) considered here. All the results assume an initial ice temperature of −15° C., which is typical for icing conditions at elevations of 10,000 feet.

### Discussion

The preceding analysis demonstrates that pulsed deicing for aircraft platforms presents a promising alternative to current ice mitigation strategies. Using the system analysis for pulsed deicing with on-aircraft integration, Table 3 summarizes the overall volume and mass requirements for the additional components required to achieve pulsed deicing on three different aircraft platforms. The results indicate that using modern energy storage methods with rationally designed charging algorithms, the integration of pulsed deicing for aircraft is a feasible approach for both commercial and military aviation platforms.

At this time, supercapacitors are the focus as the energy storage media of choice. Even though hybrid-Li-ion capacitors have lower mass (for a particular power required), supercapacitors are a more mature technology for use in aircraft-deicing applications. Supercapacitors work based on establishing the electrostatic double-layer capacitance and electrochemical pseudo-capacitance, both of which contribute to the capacitance of the conductor. The supercapacitor was developed to bridge the gap between electrostatic capacitors which have high power but low energy storage capability, and lithium-ion batteries which have high specific energy but low power density. For supercapacitors, power density is the bottleneck in sizing of the energy storage system. A storage system sized for the rated power delivery, leads to a supercapacitor bank with ˜4.2× the energy required for aircraft de-icing with a Δtₚᵤₗₛₑ=1 s. This excess energy storage is beneficial since the supercapacitor voltage decreases with energy discharged. With the additional energy storage, a deicing event reduces the supercapacitor voltage by 15%. This voltage drop is well within the regulation range of conventional power converters.

For the discharging loop, all the deicing energy may need to be provided within 1 s. Hence, for aircraft having size scales as large as a Boeing 747, the power electronics may need to process 350 KW of power. However, charging of the supercapacitor does not need to occur within 1 s. For cases where charge is obtained from the grid on the ground, charging occurs rapidly enough so as not to delay aircraft flight. For this reason, it is estimated that a 5 minute charging time for the deicing system is reasonable and conservative. Power electronics in the charging loop are sized accordingly for this criterion, with mass and volume of both the power electronics and supercapacitors presented in Table 3 for various aircraft sizes.

TABLE 3
Mass and volume estimates for pulsed deicing infrastructure assuming supercapacitor
energy storage. The power electronics (PE) results were estimated based on current state
of the art of 3 kW/kg and 20 kW/L powe rdensities including integrated thermal management.
The discharging mode was used to size the PE. Cabling and interfacial heater mass and
volume were negligible compared to the PE and energy storage.

| | Max | Energy | | Energy | | Total | Total |
|---|---|---|---|---|---|---|---|
| | Takeoff | Storage | PE | Storage | PE | Added | Added |
| | Mass | Mass | Mass | Volume | Volume | Mass | Volume |
| Aircraft | [kg] | [kg] | [kg] | [m³] | [cm³] | [kg] | [m³] |
| Cessna-172 | 1,160 | 1.67 | 3.3 | 0.014 | 500 | 5 | 0.01 |
| Embraer-175 | 40,370 | 8.35 | 17 | 0.071 | 2,500 | 25 | 0.07 |
| Boeing 747 | 410,000 | 58.33 | 116 | 0.5 | 17,500 | 175 | 0.52 |

It is important to note that the current modeling framework represents a first step to understanding the design of pulsed deicing systems for aircraft platforms. Other considerations may be taken into account when implementing the system for real aircraft. One particular concern is the chance of refreezing and ice accretion.

If an exterior superhydrophobic layer can be implemented on the electro-thermal multilayer, it may allow the thin ice-melt layer to de-adhere and flow easily down the wing shape and hence reduce the problems associated with refreezing. In addition to enhancing ice mobility, superhydrophobicity has been shown to both hinder or delay ice and frost formation on surfaces and reduce contact times and adhesion during supercooled droplet impact, preventing accretion. It is believed that the use of superhydrophobicity may reduce runback of ice by about 40% and the power required for deicing by about 80%. A superhydrophobic layer would be particularly beneficial for pulse-deicing approaches which are implemented on ground for stationary aircraft, which may accumulate snow on the aircraft body. Pulsed deicing without a superhydrophobic layer may have limitations when frost and snow are present due to the porous nature of the accreted material. Local interfacial melting, although successful, may not result in bulk frost or snow removal simply due to the wicking of the melt layer into the bulk frost/snow, inhibiting or preventing frost/snow removal. A superhydrophobic layer can ameliorate this issue by facilitating dynamic deicing and ice/snow removal, even in the absence of surface or body forces.

### Example 2: Renewable Energy Application

With the goal of achieving ultra-efficient and ultra-rapid snow/frost/ice removal from photovoltaic (PV) panels, an electro-thermal multilayer capable of superhydrophobicity, optical transparency, self-cleaning, and pulsed Joule heating near a snow/frost/ice-substrate interface has been produced and characterized. Removal of snow and frost using pulsed Joule heating has not been achieved in the past due to wicking of the thin melt layer into the porous snow and frost. As discussed above, combining nanostructures with a conformal hydrophobic coating leads to superhydrophobicity (θₐ^{app}>150° and Δθ<10°), which enables rapid shedding of liquid by droplet jumping, sliding, and rolling. To remove partially melted frost or snow from PV panels via pulsed heating, the panel cover glass is preferably rendered superhydrophobic and transparent to the solar spectrum. To achieve these optical and wetting properties, a simple and ultra-scalable fabrication method for applying superhydrophobic layers or coatings to substrates such as glass and ITO-coated glass has been developed. Accordingly, the electro-thermal multilayer 100 in this investigation includes a superhydrophobic layer 106 in addition to a heating layer 102 (the ITO) and an insulating layer 104 (the glass substrate), as illustrated in FIGS. 1A and 1B.

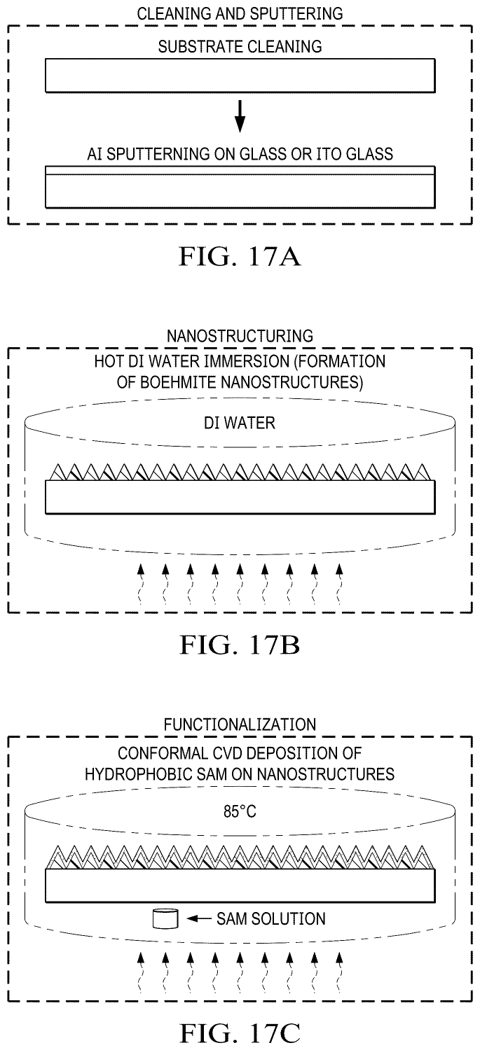

Using the approach shown schematically in FIGS. 17A-17C, a nanoscale-thick aluminum (Al) layer was deposited on a glass substrate (FIG. 17A) followed by immersion in hot deionized water to create AlO(OH) (boehmite) nanostructures (FIG. 17B), which were then conformally coated with a hydrophobic species comprising HTMS, forming the superhydrophobic layer 106 (the hydrophobic self-assembled monolayer (SAM) on the boehmite nanostructures) (FIG. 17C). The grass-like or knife-like boehmite nanostructures maintain a stable Cassie-Baxter state and a very low droplet adhesion that manifests itself in a low value of measured Δθ. The Cassie-Baxter state arises when air pockets are trapped inside the structures and therefore the liquid wets a mixture of the solid-gas surface. This state is in contrast to the Wenzel state where the liquid penetrates to the structures and the apparent droplet contact angle is reduced when compared to Cassie-Baxter state. The density and porosity of the nanostructures can be modified by varying the immersion time and temperature during fabrication.

Notably, the as-deposited Al film on the glass substrate became optically transparent after hydrothermal treatment. Since the surface roughness is sufficiently small (<30 nm), the treated film does not give rise to visible light scattering. Moreover, the boehmite nanostructures with conformal hydrophobic functionalization achieved apparent advancing contact angles of θₐ^{app}>160° with an initial as-deposited Al film thickness h_{Al}=10 nm, which renders the surface superhydrophobic. Thus, the combination of optical transparency and superhydrophobicity in the same coating allows for multi-functionality to enable desnowing and defrosting of PV panels using pulsed Joule heating. The boehmite coating shows high transparency not only in the visible spectrum (0.3˜0.8 μm), but also within the moderate infrared spectrum (<2.0 μm). For Al film thicknesses h_{Al} in excess of 100 nm, the boehmite coating becomes opaque. ITO is used in this demonstration as the heating layer due to its outstanding optical transmittance (>85%) and electrical characteristics. ITO is electrically conductive (1-250 0 sq.⁻¹), making it suitable for high power density pulsed heating.

To optimize the multifunctionality of the electro-thermal multilayer, different design combinations of the superhydrophobic coating or layer and the ITO coated glass (“ITO glass”) were investigated, where the ITO functions as the heating layer and the glass serves as the insulating layer or substrate. A variety of ITO glass samples with low sheet resistance (Rₛ=4-10 0 Ωsq.⁻¹, ˜200 nm ITO thickness) and high sheet resistance (Rₛ=70-100 Ωsq.⁻¹, ˜30 nm ITO thickness) were selected to combine with the SHP boehmite coating both on the same side of a glass (boehmite layer on top of ITO layer), as well as on the back side of the glass. The boehmite coating thickness used was fixed as h_{Al}=50 nm.

The coating results demonstrate that samples with single layer coatings (ITO-Hi: high sheet resistance ITO layer on glass, ITO-Lo: low sheet resistance ITO layer on glass and SHP-Glass: boehmite nanostructured SHP glass) have as high a transmittance as bare glass. For samples with two coating layers (ITO and boehmite), the transmittance changed. Samples with two coatings on the same side (SHP-ITO-Hi: SHP boehmite coating on high resistance ITO layer; and SHP-ITO-Lo: SHP boehmite coating on low resistance ITO layer) showed semi-transparency. However, when the two coatings were separated on each side of the glass substrate (double side samples), they showed transparency as good as the bare glass sample. The semi-transparency of the single-sided coating is attributed to increased light scattering due to the increased roughness from the ITO and boehmite layers. The roughness for transparent film formation may need to be <100 nm to ensure good transparency. Due to the anti-reflective properties of the boehmite SHP layer, double sided coating of samples with high sheet resistance (Double side SHP ITO-Hi) ensured the same transmittance levels when compared to bare glass. For applications where optical transparency is important, these results suggest that applying the coatings on opposite sides results in transparency as high as bare glass. Concurrent energy losses when the heating layer is on the backside may be minimized by minimizing the thickness of the glass. The boehmite coating not only shows minimal impact on optical properties of the substrate; in fact, it increases transmittance of the glass sample when compared to bare glass. The reflectance of bare and boehmite-coated (h_{Al}=50 nm) glass samples was quantified as a function of polarized incident angle and wavelength. It is found that the boehmite coating reduces the reflectance when compared to the uncoated glass, especially at shorter wavelengths and smaller incident angles.

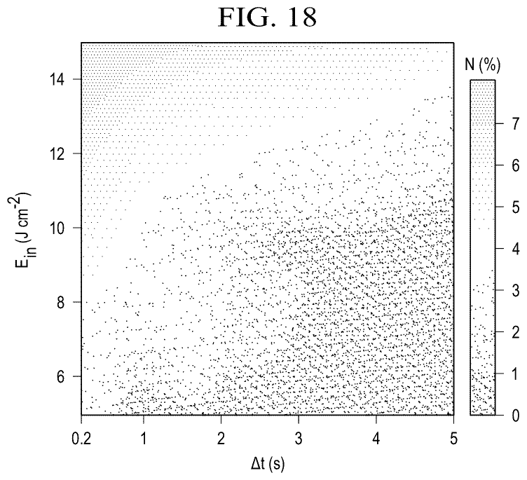

To characterize the ability of the electro-thermal multilayer to remove naturally grown frost from ambient humidity, high power density pulses were applied to the ITO layer surface while measuring the required power density and energy density to achieve frost removal. Irrespective of surface energy, lower defrosting energy is required when smaller pulse widths are used. Fundamentally, this occurs because at higher heating times, more heat is allowed to diffuse to the bulk substrate. FIG. 18 shows results from a finite volume method simulation of defrosting of a glass substrate coated with a 1 μm-thick ITO layer with convection heat transfer on one side (air side) and a constant temperature on the other side (cold plate side). The top and bottom boundaries were adiabatic due to symmetry. Shorter pulse widths ensure more frost melting, with higher spatial confinement of heat near the ITO region. Conversely, with the same input energy, the melt fraction decreases with increased pulse width as the spatial confinement of heat degrades.

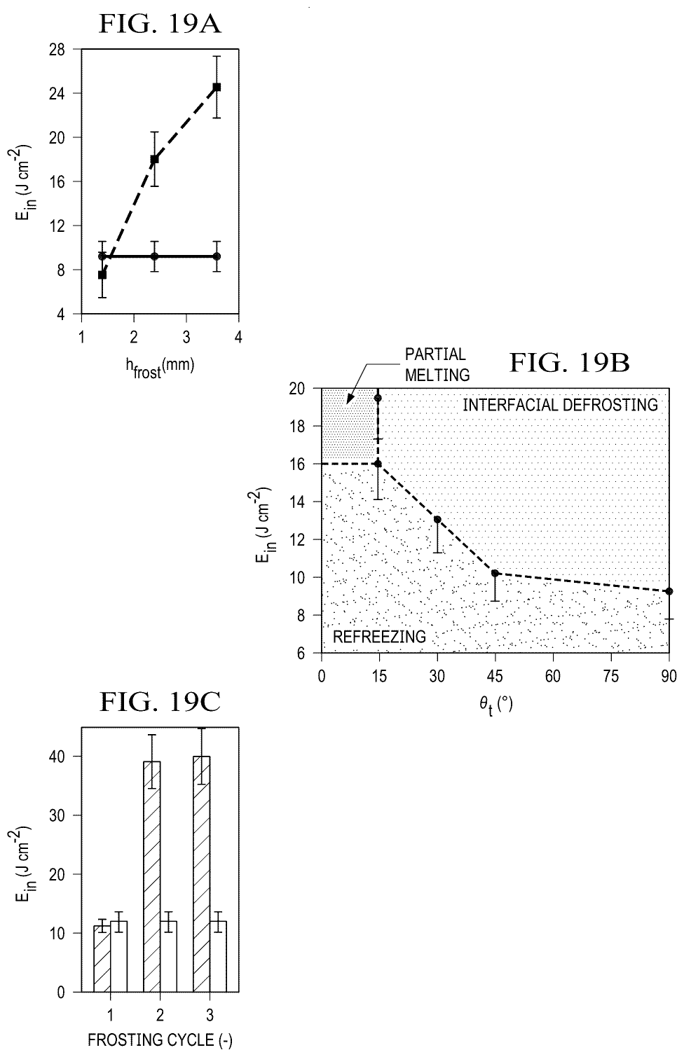

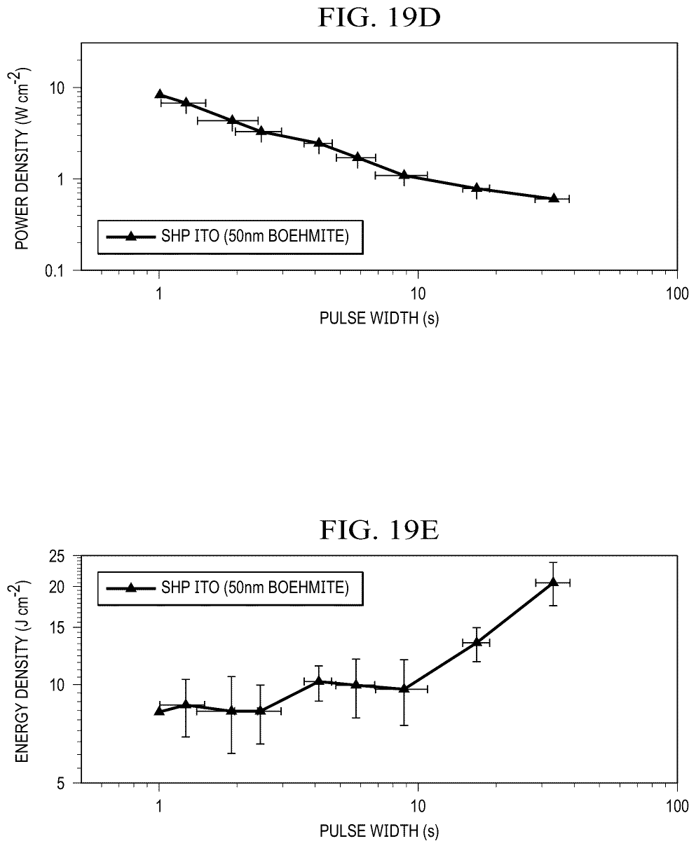

To verify the simulation results, experiments were carried out. The surface temperature was kept at −10° C.±2° C. and the relative humidity was 50%±5% for all experiments. Typically, the required defrosting energy decreases with decreasing pulse width (that is, the pulsed heating time). The experiments demonstrate defrosting energy densities <10 J cm⁻² (FIGS. 19A and 19B). When defrosting on an ITO surface, all frost melted with droplets remaining adhered to the surface due to the surface intrinsic hydrophilicity and the ability of the frost to wick the melt. To overcome this challenge and to enable only melting of a several micron thick interfacial lubricating layer to allow frost sliding, a superhydrophobic layer as described above was deposited on the ITO heating layer (SHP ITO). To achieve removal of porous frost and snow, surfaces having high apparent advancing water contact angles (θₐ^{app}) and low contact angle hysteresis (θₐ^{app}−θᵣ^{app}=Δθ, where θᵣ^{app} is the apparent receding contact angle) are highly advantageous. Referring to FIGS. 19D and 19E, applying a power density of 0.83 W cm⁻² to frost grown on the SHP ITO resulted in full melting with a required energy density of 23.7 J cm⁻² (Δtₚᵤₗₛₑ˜28.5 s). As a comparison, a one-second electrical pulse with a power density of 9.2 W cm⁻² was applied to the same surface to achieve pulsed defrosting. The pulsed heating method had a 61% decrease in energy consumption when compared to the steady heating for 28.5 s at 0.83 W cm⁻². The energy reduction translates to a 145 kJ m⁻² reduction in defrost energy consumption per defrosting cycle of a 1 m² polycrystalline Si PV panel. Previous studies have reported desnowing energies on solar cells ranging from 150 kJ m⁻² to 1200 kJ m⁻², depending on inclination angle and the amount of snowfall. These values indicate that the reduction in desnowing energy density using this pulsed method is significant for many conditions.

A second advantage of pulsed defrosting on SHP ITO is that the defrosting energy does not increase with frost thickness. To achieve pulsed defrosting, melting of an ultra-thin (<100 μm) layer is enough for the remaining frost to slide from the surface. In fact, increasing the thickness of the accumulated frost or snow aids in removal due to the higher mass and resulting gravitational force. FIG. 19A plots the experimentally measured energy required to remove different thicknesses of frost. The defrosting energy on SHP ITO is constant. In contrast, melting of the entire frost layer on ITO (melting regime) depends on frost thickness, requiring more energy for longer frosting times (higher thickness). Compared with the one-hour frosting result, the required defrosting energy increased by 138% and 226% for 2-hour and 4-hour frosting times, respectively, when operating in the melting regime (ITO).

In addition to the demonstrated defrosting on vertical surfaces, defrosting on tilted surfaces is important for renewable energy technologies such as PV panels and turbine blades. On a tilted surface, more time is required for the bulk snow/frost/ice to slide from the surface after melting the thin lubricating layer. Therefore, a larger thickness of snow/frost/ice may need to be melted to ensure that the remaining sliding layer has enough time to slide from the surface before refreezing occurs. The critical thickness of the melted water layer can be calculated through a force balance between the gravitational force and the transient and velocity-mediated shear force. Assuming a Couette flow for the thin lubricating melted water layer, the critical thickness scales as, t_{c}˜μ_{w}v/hρg sin φ, where μ_{w} is the melt water dynamic viscosity, v is the sliding speed, h is the snow/frost thickness, ρ is the ice/frost/snow density, g is the gravitational constant, and φ is the tilt angle (φ=90° for a vertical surface). Accordingly, t_{c} increases on a tilted surface and therefore more energy is required to melt a thicker lubricating water layer. Using the same defrosting power for the vertical surface may result in refreezing on the tilted surface.

To characterize the effect of tilt, pulsed defrosting was implemented for surfaces oriented at φ=45°, 30° and 15°. Although the minimum required defrosting energy increased with decreasing θₜ (FIG. 19B), it was still more efficient when compared to conventional steady heating methods. For a one-second pulse, three different regimes of interfacial defrosting, melting, and refreezing were observed. On highly tilted surfaces (θₜ=15°), lower power densities (<16 W cm⁻²) applied for a one-second pulse could not ensure complete frost removal from the surface. However, higher power densities (>19 W cm⁻²) resulted in partial melting of the frost. Therefore, a 3 mm-thick frost layer was not thick enough to achieve interfacial defrosting on highly titled surfaces (θₜ<15°). The results presented in FIG. 19B are for a constant sample size (area: 5 cm×5 cm). Increasing the sample size increases the length that snow/frost/ice needs to slide to be fully removed from the surface. Consequently, more time is required for complete frost removal on larger surfaces. A force balance between the shear forces and gravitational forces applied to the snow/frost/ice layer demonstrates how the frost vertical position (x) varies with time and t_{c}, x˜(g sin φt_{c}ρ(h−t_{c})/μ_{w})(t+t_{c}ρ(h−t_{c}))(exp(−tμᵤw/t_{c}ρ(h−t_{c})−1). In addition to energy efficiency enhancement, pulsed electro-thermal desnowing and defrosting may enable time savings. The time to defrost is key to the overall efficiency as it dictates downtime and lost energy generation. The method can be ultra-rapid (˜1 s or less), eliminating downtime.

### Additional Examples: Testing

### Cyclic Frosting-Defrosting Experiments

To conduct the experiments, a low temperature chiller (P10N9E403BR, PolyScience) with a customized actuation unit was used. Test samples were attached to the cold stage of the chiller using double sided tape (S-14668, Uline; thickness: ˜350 μm) and by using Kapton tape (KPT2-1/2,BERTECH). Two thermocouples (CHAL-002,Omega) are attached on the cold stage and sample surface to monitor the temperature. The actuation unit consists of a servo controller, motor, and horn. With the aid of the servo horn, the chiller power was controlled for long-term cycling experiments. At first, the chiller is connected to the power supply. Then, the servo controller is powered on, and the servo motor actuates the chiller by pushing the power button via a servo horn. After taking approximately 1 hour to reach the lowest temperature of the chiller (approximately −80° C.), the chiller is maintained at that temperature for another hour to complete the frosting cycle and to grow the frost to an estimated thickness of 8 mm. Then, the servo motor again actuates the horn to turn off the chiller to initiate the defrosting cycle. The duration of the defrosting cycle is approximately 2 hours, where first hour melts the frost by room temperature ambient heating, and the second hour allows the shedding of the melt and natural evaporation of remnant condensate to reduce water retention and re-frosting before the initiation of the next frosting cycle. These steps of frosting-defrosting are repeated in cycles to conduct long-term durability experiments.

To fabricate the superhydrophobic layers, copper sheets (Cu, 2.032 mm thick 8963K88, McMaster) were used as a base substrate. The fabrication process starts with cleaning the Cu tabs by dipping them for 15 min in acetone (CAS #67-64-1, Fisher Chemical), ethanol (CAS #64-17-5, Sigma Aldrich), isopropanol (CAS #67-63-0, Fisher Chemical), and deionized (DI) water (CAS #7732-18-5, Sigma Aldrich), in succession, followed by rinsing with DI water. The tabs were then dipped into a 2.0 M hydrochloric acid (CAS #7647-01-0, Sigma Aldrich) solution for 2 min to remove the native oxide layer on the surface, then rinsed multiple times with DI water and dried with clean nitrogen gas stream. Afterwards, dense blade-like nanostructured CuO surfaces were formed by immersing the cleaned tabs into a hot (90±5° C.) alkaline bath of NaClO₂ (CAS #7758-19-2, Sigma Aldrich), NaOH (CAS #1310-73-2, Sigma Aldrich), Na₃PO₄·12H₂O (CAS #10101-89-0, Sigma Aldrich), and DI water (3.75:5:10:100 wt %). The CuO nanostructured surfaces were then cleaned by rinsing with DI water and drying with a stream of nitrogen. They were then treated with an air plasma (PDC-001-HP from Harrick Plasma) with a power of 30 W for 3-5 minutes to further clean and activate the substrate. Air plasma cleaning has been shown to increase the number of hydroxyl groups on the substrate, thus enhancing adhesion. Then the superhydrophobic surface was developed by functionalizing the air plasma cleaned CuO nanostructured sample using atmospheric pressure chemical vapor deposition (CVD) of a fluorinated silane ((Heptadecafluoro-1,1,2,2 tetrahydrodecyl) trimethoxysilane, HTMS, Gelest, CAS #83048-65-1). Reduction of humidity during the CVD step can be critical for ensuring the coating adherence to the substrate. In these experiments, this was achieved by pre-heating the beaker and sample in the furnace at ˜80° C. for 15 minutes prior to conducting the CVD process.

The superhydrophobic surface or layer experiences condensation frosting, which includes several subsequent events: supercooled condensation, onset of freezing, frost halo formation, inter-droplet ice bridging, cluster formation, and frost densification. During supercooled condensation, as the substrate temperature reaches below the dew point (˜10° C.) and the ambient atmosphere reaches the required degree of supersaturation, atmospheric water vapor nucleates heterogeneously on the substrate and supercooled water droplets keep growing from the ambient vapor. Once the substrate reaches the sub-zero temperatures and overcomes the ice-nucleation energy barrier, the onset of freezing and frost halo formation begins. This is followed by newly frozen water droplets harvesting water from their adjacent water droplets and growing ice bridges toward them. Finally, once the global freeze front has propagated though the entire condensate population, a network of interconnected frozen droplets provides the foundation upon which out-of-plane frost (dendrites) growth can happen.

During the early stages of the cyclic experiment (t=5 min; T=0° C.), small subcooled droplets cover the surface. At later times, due to increased subcooling, droplets freeze, form bridges, and frost grows out-of-plane and densifies. Once the frosting phase of the cycle is complete, the total frost thickness was estimated to be ˜8.2±1.3 mm using optical imaging from the side. The ambient heated defrosting process involves top-down melting, where the accumulated frost always melted from the free interface between the air-frost. The melting began at the tips of the frost dendrites due to absorption of heat from the ambient air. Once all if the dendrites on the surface had melted, in-plane frost began to melt. Over time, the thickness of the frost layers gradually decreases, and highly mobile slush regions were visible all over the surface. At time t=165 min and T=0° C., the removal of slush inducing shear force on the surface was observed. Due to the nature of the superhydrophobic surface, after completing the defrosting cycle, condensate retention on the surface was not observed. However, the surface was maintained at room temperature for another hour to allow for any trapped micro-droplet evaporation. The complete removal of any melt water from the surface was particularly important as it prevents a phenomenon called re-frosting. Re-frosting occurs when melt water retained on the surface provides active nucleation sites for frost formation in subsequent frost cycles and acts to alter the nature of the frost layer, as well as the final frost thickness as the number of cycles proceeds beyond the initial cycle. In order to avoid these confounding experimental parameters, re-frosting was avoided in these experiments. To assess long-term durability, the experiment was conducted for a total of 1000 frosting-defrosting cycles. This duration was chosen to simulate the practical usage of anti-frosting surfaces in real-world situations, such as supermarket display cases that require periodic defrosting with 2-4 cycles per day. The 1000 cycles equate to a display case operating for approximately 3 years if defrosted once per day, or 9 months if defrosted 4 times per day. Thus, this experiment provides a prediction of the multi-month performance of anti-frosting surfaces under real-world conditions.

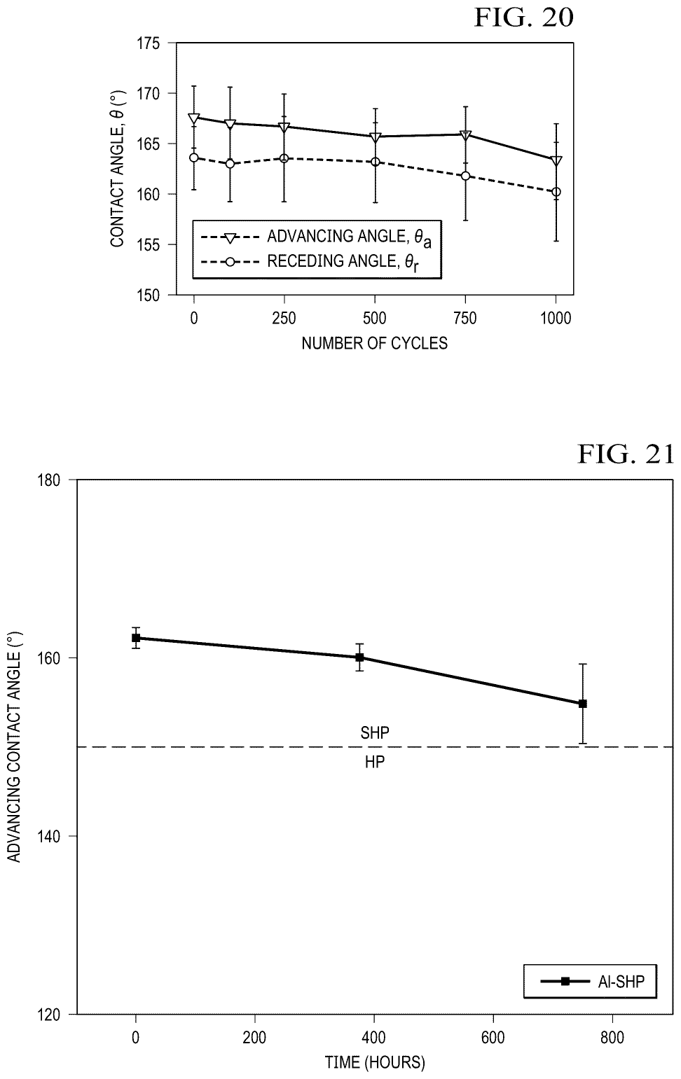

During the frosting/defrosting cycles, surface nanostructures may experience forces resulting from the volumetric expansion of freezing droplets and shear forces induced by the shedding of frost/melt. To evaluate micro/nanostructure robustness of the CuO-based superhydrophobic layer, scanning electron microscopy (SEM) was conducted and the results were compared with those of a fresh surface (0 cycles). The SEM images of the samples show undamaged CuO micro-blades even after 1000 cycles of testing, demonstrating the robustness of the surface structure. To characterize the surface wettability change after conducting the cycling experiments, deionized (DI) water droplet contact angles were measured using a microgoniometer (MCA-3, Kyowa Interface Science), where liquid droplets (100 nL) were dynamically grown to measure the apparent advancing contact angles. The microgoniometer droplet dispenser was then turned off, and the deposited droplets were allowed to continuously evaporate to obtain the apparent receding contact angles. Similar to the observed structural integrity, the droplet surface interaction remains consistent after 1000 cycles, as shown in FIG. 20. A slight change in apparent contact angles and contact angle hysteresis indicates reasonable chemical robustness of the functional HTMS layer.

### Weathering Testing

Six different electro-thermal multilayer samples underwent weathering testing to evaluate their durability under environmental conditions. The samples included titanium-coated aluminum with Parylene C insulation in between, indium tin oxide (ITO)-coated anodized aluminum, aluminum with a superhydrophobic (SHP) coating, ITO-coated anodized aluminum with a SHP coating, ITO-coated polyethylene terephthalate (PET) film, and ITO-coated polyethylene naphthalate (PEN) film, representing various combinations of heating, insulation, and/or superhydrophobic layers, prepared as described above.

The weathering testing was conducted using the QUV Accelerated Weathering Tester. Tested specimens were mounted on the sample holders using double-sided Kapton tape and were exposed to harsh weathering conditions of high temperature, UV light, condensation, and water spray.

The testing was carried out following cycle type 7 exposure conditions of the Standard Practice for Operating Fluorescent Ultraviolet (UV) Lamp Apparatus for Exposure of Materials (ASTM G154). The cyclic test consists of 8 hours of UV exposure at a temperature of 60 (±3) ° C. and at an irradiance of 1.55 W/(m²·nm), 0.25 hours of water spray at a volumetric flow rate of 7 L/min, and then 3.75 hours of condensation at an exposure temperature of 50 (±3) ° C. Each test was continued for 750 hours to demonstrate the long-term durability of the tested specimens, and samples were repositioned every 150 hours in accordance with the standard. During the testing, the lab temperature was maintained at 25 (±5) ° C.

After 750 hours of weathering testing, all samples except those coated with Ti and Parylene C insulation showed no visible color, texture, or roughness change. Contact angle measurements were performed for the aluminum sample with SHP coating. The advancing contact angle of the SHP coating on bare aluminum substrate decreased from 162° to 155° after 750 hours of weathering testing, still demonstrating excellent superhydrophobicity, as shown in FIG. 21.

### Infrared Imaging of Patterned Heating Layers

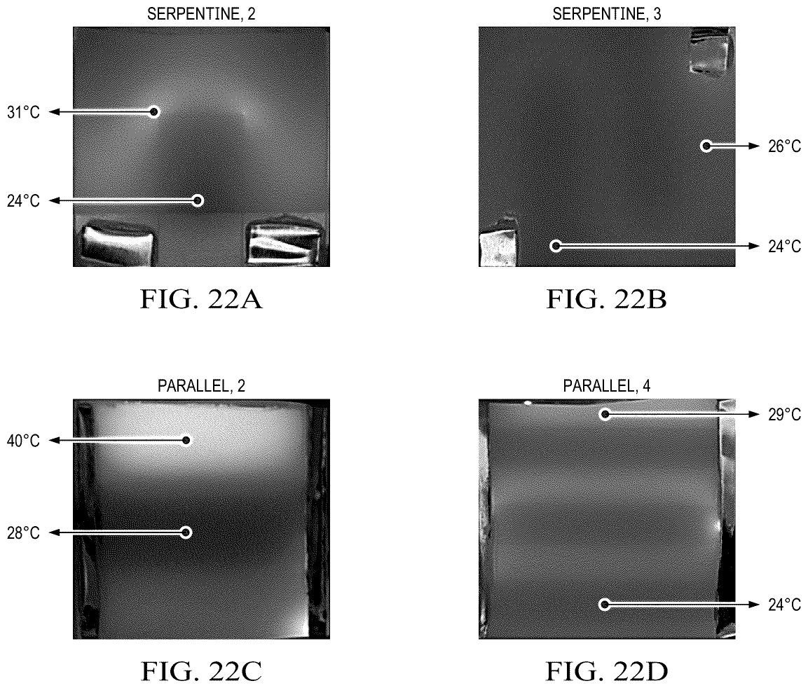

Infrared imaging of patterned heating layers highlights the ability to selectively heat certain areas of the layer in order to achieve non-uniform temperature distributions across the surface. This can be potentially advantageous in developing localized thermal gradients which may induce thermomechanical stresses capable of compromising the structure of the ice layer, which could aid in dislodging the ice chips from the surface. FIGS. 22A-22D provide grayscale infrared images showing temperature differences in different regions of patterned heating layers having serpentine and parallel patterns while heated at 60 V.

The subject matter of the disclosure may also relate to the following aspects:

A first aspect relates to an electro-thermal multilayer for defrosting, desnowing, and deicing, the electro-thermal multilayer comprising: a heating layer on an insulating layer; and a superhydrophobic layer on the insulating layer.

A second aspect relates to the electro-thermal multilayer of the first aspect, wherein the heating layer and the superhydrophobic layer are on the same side of the insulating layer, the superhydrophobic layer being positioned directly on the heating layer, and the heating layer being positioned directly on the insulating layer.

A third aspect relates to the electro-thermal multilayer of the first aspect, wherein the heating layer and the superhydrophobic layer are on opposing sides of the insulating layer, the insulating layer being between the superhydrophobic layer and the heating layer.

A fourth aspect relates to the electro-thermal multilayer of any preceding aspect, wherein the heating layer is a patterned heating layer comprising a surface area smaller than that of the insulating layer.

A fifth aspect relates to the electro-thermal multilayer of any preceding aspect, wherein the heating layer is configured for electrical connection to a source of pulsed power.

A sixth aspect relates to the electro-thermal multilayer of any preceding aspect being self-supporting for use as a module.

A seventh aspect relates to the electro-thermal multilayer of any preceding aspect, wherein the insulating layer is a rigid or flexible substrate having a thickness greater than 1 mm.

An eighth aspect relates to the electro-thermal multilayer of any preceding aspect being optically transparent.

A ninth aspect relates to the electro-thermal multilayer of any preceding aspect being supported on a substrate.

A tenth aspect relates to the electro-thermal multilayer of the preceding aspect, wherein the substrate is part or all of a component used in renewable energy, thermal management, or aerospace applications.

An eleventh aspect relates to the electro-thermal multilayer of any preceding aspect, wherein the component is an aircraft wing, a photovoltaic panel, a wind turbine blade, a heat exchanger coil or fin, or another part.

A twelfth aspect relates to the electro-thermal multilayer of any preceding aspect, wherein the superhydrophobic layer comprises nanostructured surface protrusions with a hydrophobic species conformally coated thereon.

A thirteenth aspect relates to the electro-thermal multilayer of any preceding aspect, wherein the heating layer comprises a conductive material selected from the group consisting of a metal, a metal alloy, a conductive oxide, a carbon-based material, and a conductive polymer.

A fourteenth aspect relates to the electro-thermal multilayer of the preceding aspect, wherein the conductive material is selected from the group consisting of: titanium, stainless steel, platinum, silver, gold, an iron-chromium-aluminum alloy, a nickel-chromium alloy (e.g., 80Ni-20Cr), a copper-nickel alloy (e.g., 90Cu-10Ni or 70Cu-30Ni), indium-tin oxide (ITO), fluorine-doped tin oxide (FTO), aluminum-doped zinc oxide (AZO), gallium-doped zinc oxide (GZO), carbon nanotubes, graphene, poly(3,4-ethylenedioxythiophene) (PEDOT).

A fifteenth aspect relates to the electro-thermal multilayer of any preceding aspect, wherein the insulating layer comprises a polymer, a glass, an insulating oxide, and/or anodized aluminum.

A sixteenth aspect relates to the electro-thermal multilayer of any preceding aspect, wherein the polymer comprises parylene, polydimethylsiloxane (PDMS), or epoxy.

A seventeenth aspect relates to a system configured for electro-thermal defrosting, desnowing and/or deicing, the system comprising: a component susceptible to accumulation of ice, frost, and/or snow; an electro-thermal multilayer disposed on the component, the electro-thermal multilayer comprising: a heating layer on an insulating layer, the heating layer being configured for electrical connection to a source of pulsed power; and optionally a superhydrophobic layer on the insulating layer.

An eighteenth aspect relates to the system of any preceding aspect, wherein the electro-thermal multilayer is adhered to the component as a coating.

A nineteenth aspect relates to the system of any preceding aspect, wherein the electro-thermal multilayer is removably secured to the component as a module.

A twentieth aspect relates to the system of any preceding aspect, wherein any ice, frost, and/or snow that accumulates on the component is subjected to gravitational and/or shear forces during use of the component.

A twenty-first aspect relates to the system of any preceding aspect, wherein the component is a photovoltaic panel, a wind turbine blade, a heat exchanger coil or fin, or an aircraft wing, or another part.

A twenty-second aspect relates to the system of any preceding aspect, further comprising a source of pulsed power.

A twenty-third aspect relates to the system of any preceding aspect, wherein the component is a wing or another part of an electrified aircraft, and wherein the source of pulsed power is onboard the electrified aircraft.

A twenty-fourth aspect relates to the system of any preceding aspect, wherein the source of pulsed power comprises a rechargeable energy storage device.

A twenty-fifth aspect relates to the system of any preceding aspect, wherein the rechargeable energy storage device comprises a supercapacitor.

A twenty-sixth aspect relates to the system of any preceding aspect, wherein the optional superhydrophobic layer is present and is positioned directly on the heating layer, and wherein the heating layer is positioned directly on the insulating layer.

A twenty-seventh aspect relates to the system of any preceding aspect, wherein the optional superhydrophobic layer is present, and wherein the insulating layer lies between the superhydrophobic layer and the heating layer.

A twenty-eighth aspect relates to the system of any preceding aspect, wherein the heating layer is a patterned heating layer comprising a surface area smaller than that of the insulating layer.

A twenty-ninth aspect relates to the system of any preceding aspect, wherein the electro-thermal multilayer is optically transparent.

A thirtieth aspect relates to the system of any preceding aspect, wherein the optional superhydrophobic layer is present and comprises nanostructured surface protrusions with a hydrophobic species conformally coated thereon.

A thirty-first aspect relates to the system of any preceding aspect, wherein the heating layer comprises a conductive material selected from the group consisting of a metal, a metal alloy, a conductive oxide, a carbon-based material, and a conductive polymer.

A thirty-second aspect relates to the system of any preceding aspect, wherein the conductive material is selected from the group consisting of: titanium, stainless steel, platinum, silver, gold, an iron-chromium-aluminum alloy, a nickel-chromium alloy (e.g., 80Ni-20Cr), a copper-nickel alloy (e.g., 90Cu-10Ni or 70Cu-30Ni), indium-tin oxide (ITO), fluorine-doped tin oxide (FTO), aluminum-doped zinc oxide (AZO), gallium-doped zinc oxide (GZO), carbon nanotubes, graphene, poly(3,4-ethylenedioxythiophene) (PEDOT).

A thirty-third aspect relates to the system of any preceding aspect, wherein the insulating layer comprises a polymer, a glass, an insulating oxide, and/or anodized aluminum.

A thirty-fourth aspect relates to the system of the preceding aspect, wherein the polymer comprises parylene, polydimethylsiloxane (PDMS), or epoxy

A thirty-fifth aspect relates to an electro-thermal method of defrosting, desnowing and/or deicing, the method comprising: providing a component having an electro-thermal multilayer thereon, the electro-thermal multilayer comprising a heating layer on an insulating layer, and an optional superhydrophobic layer on the insulating layer; using the component in environmental conditions sufficient to freeze water, whereby frost, snow, and/or ice accumulates on part or all of the component; subjecting the frost, snow, and/or ice to gravitational and/or shear forces during use of the component; and applying an electrical pulse to the heating layer to induce interfacial melting of the frost, snow, and/or ice, thereby forming a melted layer on the component, whereby the frost, snow, and/or ice slides along the melted layer in a direction determined by the gravitational and/or shear forces and is thereby removed from the component.

A thirty-sixth aspect relates to the electro-thermal method of any preceding aspect, wherein the electrical pulse has a power density in a range from 1 W/cm² to 10 W/cm².

A thirty-seventh aspect relates to the electro-thermal method of any preceding aspect, wherein the electrical pulse has a pulse width in a range from 100 ms to 5 s.

A thirty-eighth aspect relates to the electro-thermal method of any preceding aspect, wherein the electrical pulse is applied two or more times.

A thirty-ninth aspect relates to the electro-thermal method of any preceding aspect, wherein a required voltage to remove the frost, snow, and/or ice is about 1 kV or less, about 800 V or less, or about 600 V or less.

A fortieth aspect relates to the electro-thermal method of any preceding aspect, wherein a required energy density to remove the frost, snow, and/or ice is less than 10 J/cm.

A forty-first aspect relates to the electro-thermal method of any preceding aspect, wherein the electro-thermal multilayer is adhered to the component as a coating.

A forty-second aspect relates to the electro-thermal method of any preceding aspect, wherein the electro-thermal multilayer is removably secured to the component as a module.

A forty-third aspect relates to the electro-thermal method of any preceding aspect, wherein the component is a photovoltaic panel, a wind turbine blade, a heat exchanger coil or fin, or an aircraft wing, or another part.

A forty-fourth aspect relates to the electro-thermal method of any preceding aspect, wherein the component is a wing or another part of an electrified aircraft, and wherein the electrical pulse is provided by a source of pulsed power onboard the electrified aircraft.

A forty-fifth aspect relates to the electro-thermal method of any preceding aspect, wherein the component is a wing or another part of an electrified aircraft, and wherein the electrical pulse is provided by a ground-based source of pulsed power.

A forty-sixth aspect relates to the electro-thermal method of any preceding aspect, wherein the source of pulsed power comprises a rechargeable energy storage device, such as a supercapacitor.

A forty-seventh aspect relates to the electro-thermal method of any preceding aspect, wherein the electro-thermal multilayer has any or all of the features recited in any preceding aspect.

To clarify the use of and to hereby provide notice to the public, the phrases “at least one of <A>, <B>, . . . and <N>” or “at least one of <A>, <B>, . . . or <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

While various embodiments have been described, it will be apparent to those of ordinary skill in the art that many more embodiments and implementations are possible. Accordingly, the embodiments described herein are examples, not the only possible embodiments and implementations.

1. An electro-thermal method of defrosting, desnowing and/or deicing, the method comprising:
providing a component having an electro-thermal multilayer thereon, the electro-thermal multilayer comprising a heating layer on an insulating layer;
using the component in environmental conditions sufficient to freeze water, whereby frost, snow, and/or ice accumulates on part or all of the component;
subjecting the frost, snow, and/or ice to gravitational and/or shear forces during use of the component; and
applying an electrical pulse to the heating layer to induce interfacial melting of the frost, snow, and/or ice, thereby forming a melted layer on the component,
whereby the frost, snow, and/or ice slides along the melted layer in a direction determined by the gravitational and/or shear forces and is thereby removed from the component.

2. The electro-thermal method of claim 1, wherein the electro-thermal multilayer further comprises a superhydrophobic layer.

3. The electro-thermal method of claim 1, wherein the electrical pulse has a power density in a range from 1 W/cm² to 10 W/cm².

4. The electro-thermal method of claim 1, wherein the electrical pulse has a pulse width in a range from 100 ms to 5 s.

5. The electro-thermal method of claim 1, wherein the electrical pulse is applied two or more times.

6. The electro-thermal method of claim 1, wherein a required voltage to remove the frost, snow, and/or ice is about 1 kV or less, and/or
wherein a required energy density to remove the frost, snow, and/or ice is less than 10 J/cm.

7. The electro-thermal method of claim 1, wherein the electro-thermal multilayer is adhered to the component as a coating.

8. The electro-thermal method of claim 1, wherein the electro-thermal multilayer is removably secured to the component as a module.

9. The electro-thermal method of claim 1, wherein the component is a photovoltaic panel, a wind turbine blade, a heat exchanger coil or fin, or an aircraft wing, or another part.

10. An electro-thermal multilayer for defrosting, desnowing, and deicing, the electro-thermal multilayer comprising:
a heating layer on an insulating layer; and
a superhydrophobic layer on the insulating layer.

11. The electro-thermal multilayer of claim 10, wherein the heating layer and the superhydrophobic layer are on the same side of the insulating layer,
the superhydrophobic layer being positioned directly on the heating layer, and the heating layer being positioned directly on the insulating layer.

12. The electro-thermal multilayer of claim 10, wherein the heating layer and the superhydrophobic layer are on opposing sides of the insulating layer,
the insulating layer being between the superhydrophobic layer and the heating layer.

13. The electro-thermal multilayer of claim 10, wherein the heating layer is a patterned heating layer comprising a surface area smaller than that of the insulating layer.

14. The electro-thermal multilayer of claim 10, wherein the heating layer comprises a conductive material selected from the group consisting of a metal, a metal alloy, a conductive oxide, a carbon-based material, and a conductive polymer.

15. The electro-thermal multilayer of claim 10, wherein the insulating layer comprises a polymer, a glass, an insulating oxide, and/or anodized aluminum.

16. A system configured for electro-thermal defrosting, desnowing and/or deicing, the system comprising:
a component susceptible to accumulation of ice, frost, and/or snow;
an electro-thermal multilayer disposed on the component, the electro-thermal multilayer comprising:
a heating layer on an insulating layer, the heating layer being configured for electrical connection to a source of pulsed power.

17. The system of claim 16, wherein the electro-thermal multilayer further includes a superhydrophobic layer.

18. The system of claim 16, wherein the electro-thermal multilayer is adhered to the component as a coating.

19. The system of claim 16, wherein the electro-thermal multilayer is removably secured to the component as a module.

20. The system of claim 16, wherein the component is a photovoltaic panel, a wind turbine blade, a heat exchanger coil or fin, or an aircraft wing, or another part.
